(19) United States
(12) Patent Application Publication
(10) Pub. No.: US 2004/0232813 A1
(43) Pub. Date: Nov. 25, 2004

(54) Electronic display-use filter and electronic display unit using the filter

(76) Inventors: Tomomi Nakano, Mie (JP); Yukinari Haraguchi, Mie (JP); Tetsuo Ozawa, Kanagawa (JP); Yasuyo Saito, Kanagawa (JP)

Correspondence Address: WENDEROTH, LIND & PONACK, L.L.P., 2033 K STREET N. W., SUITE 800, WASHINGTON, DC, 20006-1021, US

(21) Appl. No.: 10/480,455

(22) PCT Filed: Jun. 12, 2002
(86) PCT No.: PCT/JP02/05886

(30) Foreign Application Priority Data
Jun. 12, 2001 (JP) 2001-176556
Jun. 18, 2001 (JP) 2001-183313
Jun. 10, 2002 (JP) 2002-168930

(51) Int. Cl. G02B 5/20; F21V 9/00; H05B 33/12

(52) U.S. Cl. 313/112; 313/111; 313/113; 428/917; 428/352; 428/41.8; 428/480; 428/411.1; 252/582; 257/98

(57) ABSTRACT

A filter for an electronic display having at least one minimum value of transmittance in a visible light wavelength range of 400-700 nm, if transmittances (%) a, b and c at 435, 545 and 610 nm are compared, the difference between the maximum and minimum values of transmittance (%) is restricted to not more than 10, so that even if external light is a fluorescent lamp in which large emission peaks are present at 435, 545 and 610 nm, such as F10 and F6, the balance of the emission spectrum of the fluorescent lamp will not be lost due to the filter, thereby reducing unnatural coloring of the filter itself, which is installed at the front side of the electronic display, due to external light.

### TECHNICAL FIELD TO WHICH THE INVENTION BELONGS

This invention relates to a filter for an electronic display installed on the front side of an electronic display such as a plasma display or an organic EL display and having the function of removing unnecessary emittance components, and particularly to a filter for an electronic display which can improve the contrast of an electronic display by reducing external light without weakening the emittance intensity of the electronic display.

It also relates to a filter for an electronic display which is less liable to unnatural coloring of the filter itself due to external light.

It further relates to a filter in which broken pieces will not scatter if the plasma display is destroyed by accident.

### PRIOR ART

In recent years, as display panels for various electronic devices, electronic displays such as plasma displays and organic EL displays are used.

On the front side of such an electronic display, a filter is installed to remove unnecessary emittance components, thereby making displayed colors brilliant.

For example, with a plasma display, a mixed gas of xenon and neon is excited by discharge to radiate vacuum ultraviolet rays, thereby obtaining three primary colors using the emission of fluorescent substances of red, blue and green. At this time, when the neon atoms are excited and then return to a normal state, so-called neon orange light whose center is around 600 nm is emitted. Thus, a plasma display has a defect that orange color is mixed with red, so that brilliant red color is not obtainable. Thus, for a plasma display, a filter having the function of absorbing and removing neon orange light, such as a filter which locally reduces the transmittance of neon orange light is provided on the front side of the display.

Problems the Invention Intends to Solve

Electronic displays are installed at places where they are exposed to various kinds of external light such as fluorescent light and solar light. Thus, external light passes through the filter on the front side of the electronic display and external light components that have been reflected at the surface of the electronic display pass through the filter again and reach human eyes.

With an electronic display that uses a fluorescent substance such as a plasma display, since the reflectance of the display surface is large, external light reflected at the surface of the electronic display makes black portions of the screen look whitish, so that no good contrast is obtainable. Since this type of conventional filters for removing unnecessary reflected components of external light absorb and cut unnecessary external light by reducing the transmittance, they simultaneously cut emissions of the electronic display as well. Thus, the effect of improving contrast is low. Also, they lower the emission brightness of the electronic display.

Further, since external light passes through the filter installed on the front side of the electronic display twice, and when it passes through the filter, some of light components are absorbed, the balance of spectrum of external light may be lost, so that the filter itself looks unnaturally colored e.g. bluish purple or reddish purple.

In particular, among external lights, in the case of fluorescent lamps such as three band emitting fluorescent lamps F10 (JIS Z8719-1996) and ordinary fluorescent lamps F6 (JIS Z8719-1996), as shown in FIG. 6, large emitting peaks are present at 435 nm, 545 nm and 610 nm. Therefore, the balance of spectra tends to be lost due to absorption by the filter, so that the filter itself tends to be colored unnaturally.

On the other hand, the plasma display itself is ordinarily formed of glass, so that it is weak to impact, and if impact is applied due to an accident during transportation or after installation, it tends to get broken and scatter.

A first object of the present invention is to remove unnecessary external light by providing it on the front side of an electronic display, thereby improving the contrast of the electronic display.

A second object of the present invention is to prevent unnatural coloring of the filter itself due to external light.

A third object of the present invention is to provide a filter which can be easily mounted on the surface of a plasma display during the manufacturing steps of the plasma display or after manufacture and which has the effect of preventing scattering of broke pieces even if the plasma display should be broken.

Means to Solve the Problems

In order to solve the first problem, the present invention provides a filter for an electronic display mounted on the front surface of the electronic display, characterized in that it has a minimum value of transmittance in a wavelength range of 530-600 nm, and that the luminous transmittance Y1 using an emission spectrum of the electronic display on which it is to be mounted is 35% or over and higher than the luminous transmittance Y2 using an emission spectrum (JIS Z8719-1996) of an ordinary fluorescent lamp F6.

In the filter for an electronic display which solves the first problem, the relation between the luminous transmittances Y1 and Y2 should be such that a filter contrast value C expressed by the formula (1)

C═(Y1)/(Y2)² (1)

is not less than 2.4.

The filter for an electronic display which solves the first problem is characterized in that the filter contains a compound having the maximum absorption in a wavelength range of 530-600 nm so that the filter has a minimum value of transmittance in the wavelength range of 530-600 nm.

Further, the filter for an electronic display which solves the first problem is characterized in that the compound having the maximum absorption in the wavelength range of 530-600 nm is a squarylium compound expressed by the following formula (IA)

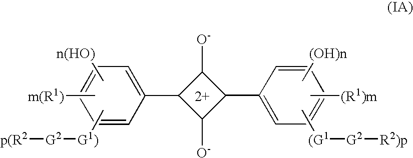

[wherein R¹ is an alkyl group which may have a substituent, an alkoxy group which may have a substituent, an aryl group which may have a substituent, an aryoloxy group which may have a substituent, or a halogen atom. Adjacent R¹'s may be coupled together to form an alkanediyl or alkylenedioxy group.

R² is a hydrogen atom or a monohydric substituent, G¹ is a group expressed by —NR³— (wherein R³ is a hydrogen atom or an alkyl group), or an oxygen atom, G² is a carbonyl group or a sulfonyl group (if G² is a sulfonyl group, R² is not a hydrogen atom.).

m, n and p are integers equal to or greater than 0, m+n+p being not more than 5.

These substituents on the benzene rings may be different from each other between the benzene rings. If m and n are 2 or larger in one benzene ring, the groups expressed by R¹ and G¹-G²-R² may be different from other groups in the same one benzene ring.]

Next, in order to solve the second problem, the present invention provides a filter for an electronic display wherein it has at least one minimum value of transmittance in a visible light wavelength range of 400-700 nm and the difference between the minimum transmittance (%) among the local minimum transmittances and the maximum transmittance (%) in the visible light range is 10 or greater, and wherein when the transmittances (%) at wavelengths of 435 nm, 545 nm and 610 nm are compared, the difference between the maximum and minimum values of transmittance at these wavelengths is not more than 10.

Since in the filter of the present invention that solves the second problem, the difference in transmittance (%) at 435, 545 and 610 nm is suppressed to 10 or under, even if the external light is a fluorescent lamp in which large emission peaks exist at 435, 545 and 610 nm, such as F10 or F6, the balance of the emission spectrum will not be lost so much that the filter will not be unnaturally colored due to external light.

The difference between the maximum and minimum values of the transmittances (%) at 435, 545 and 610 nm is preferably 5 or under.

In the present invention that solves the second problem, as described above, in order not to lose balance of the emission spectrum of external light, it is important to keep the difference between the maximum and minimum values of transmittances (%) at wavelengths of 435, 545 and 610 nm under 10. The transmittances (%) themselves are not limited only if they are in the range of 80-5%.

If the filter contains a compound having maximum absorption near one of wavelengths 435, 545 and 610 nm, the transmittances at these wavelengths can be made equal.

The filter for an electronic display according to the present invention has at least one minimum value of transmittance in the visible light wavelength range of 400-700 nm to remove unnecessary emission components. For example, in the case of a filter for a plasma display, in order to absorb neon orange light, a minimum value of transmittance is provided in the wavelength range of 530-600 nm.

That is, having a local minimum value of transmittance in the wavelength range of 530-600 nm means that light beams in this range are cut. Here, “the local minimum value” is synonymous with the meaning used with reference to a graph of a curve of the secondary function, and means a turning point where it changes from reduction to increase. Thus, it does not mean the smallest value.

The filter for an electronic display according to the present invention, as described above, has a layer having a minimum value of transmittance in a predetermined wavelength range. Besides this layer, a layer containing an ultraviolet absorber, a near infrared cutting layer, an electromagnetic wave shielding layer, a reflection-preventive layer, non-glare layer, and the like are preferably provided in combination.

In order to solve the third problem, according to the present invention, a filter is provided which can be easily mounted to the surface of a plasma display during manufacturing steps, or after manufacture of the plasma display and which has scattering-preventive effects which even if the plasma display should be broken, their pieces will never scatter, by providing a structure in which two or more transparent resin substrate layers and two or more adhesive layers are laminated together.

Further, in the present invention which solves the third problem, the transparent resin substrate layers are each 40-3000 μm, preferably 40-300 μm and the adhesive layers are each 5-3000 μm, preferably 10-100 μm.

In the present invention that solves the third problem, the transparent resin substrate layers have a tear strength of 1.5 N/mm or over, and the ratio of longitudinal tear strength/transverse tear strength is 0.5-2.0.

Further, in the present invention that solves the third problem, the transparent resin substrate comprises a polyester resin having a visible light beam transmittance of 70% or over.

Further, in the present invention that solves the third problem, one of the adhesive layers is an adhesive layer to be stuck on the front side of a plasma display panel with a release film provided on the surface thereof.

The filter of the present invention can be used for an electronic display.

### BRIEF DESCRIPTION OF THE DRAWINGS

FIG. 1 is a structure explanatory view showing the filter for an electronic display of the present invention which solves the first problem, mounted on the front side of an electronic display, thereby reducing reflected light of external light on the surface of the electronic display without checking the emission of the electronic display.

FIG. 2 is a characteristic graph showing an emission spectrum of an electronic display comprising a plasma display, an emission spectrum of an ordinary fluorescent lamp F6, and a transmittance spectrum of a filter for an electronic display.

FIG. 3 is a characteristic graph showing an emission spectrum of a plasma display after passing the filter for an electronic display of the present invention that solves the first problem, and an emission spectrum of external light (ordinary fluorescent lamp F6).

FIG. 4 is a graph showing a transmittance spectrum in a visible light area of the filter for an electronic display of the present invention that solves the second problem.

FIG. 5 is a graph showing another example of a transmittance spectrum in a visible light area of the filter for an electronic display of the present invention that solves the second problem.

FIG. 6 is a characteristic graph showing emission spectra of various kinds of external light.

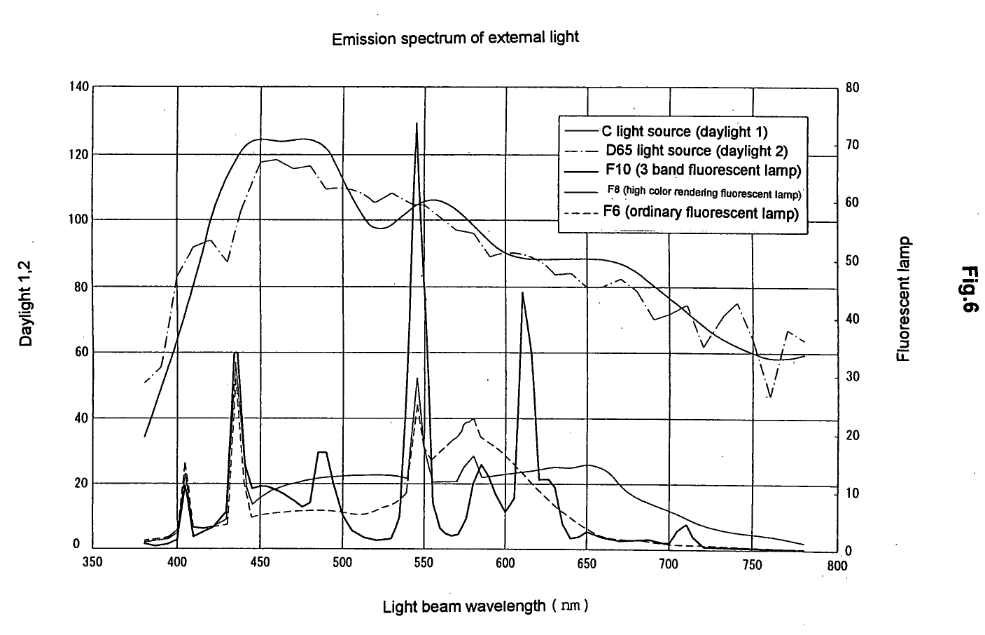

FIG. 7 is an explanatory view showing layer structure of the filter in Embodiment 6.

### EMBODIMENTS OF THE PRESENT INVENTION

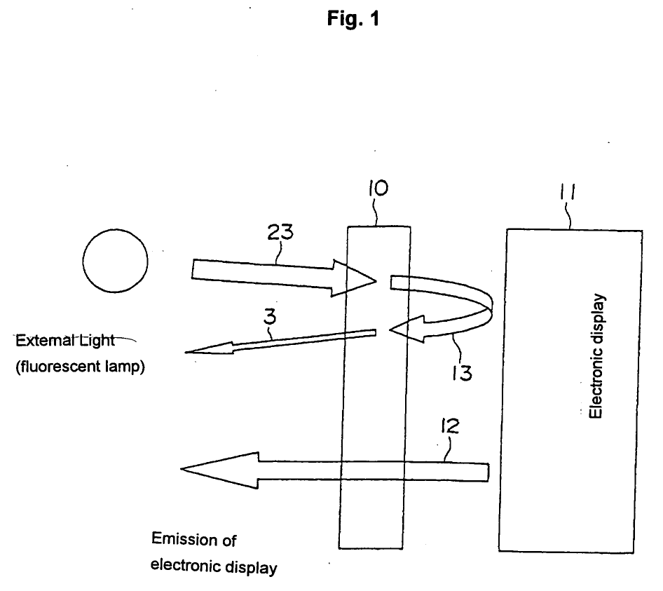

Hereinbelow, further description will be made about the embodiments of the filter for an electronic display according to the present invention. FIG. 1 is a structure explanatory view conceptually showing a state in which a filter 10 for an electronic display according to the present invention is placed on the front side of an electronic display 11 to reduce reflected light 13 of external light reflected on the surface of the electronic display without significantly interfering light emission 12 of the electronic display.

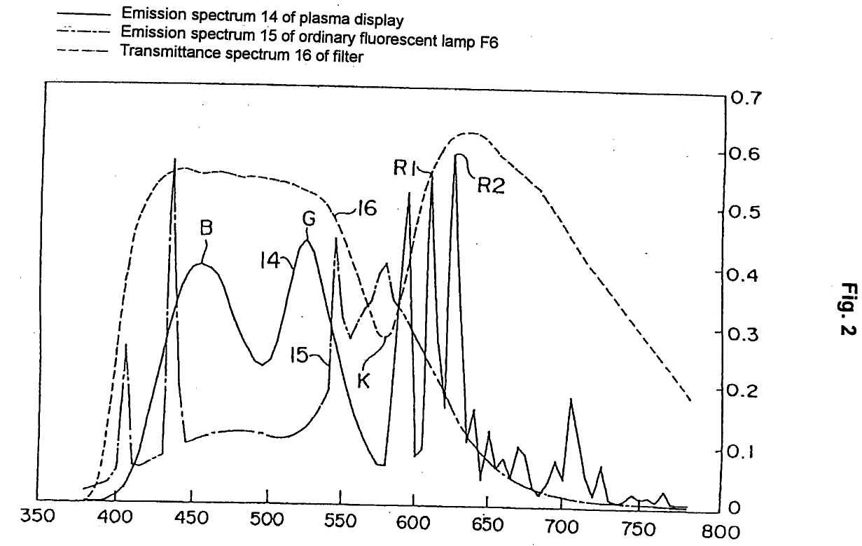

FIG. 2 is a characteristic graph showing the emission spectrum (emission spectrum 14) of an electronic display comprising a plasma display, the emission spectrum (emission spectrum 15) of an ordinary fluorescent lamp F6, and the transmission spectrum (transmission spectrum 16) of a filter for an electronic display. The ordinary fluorescent lamp F6 is a widely used ordinary fluorescent lamp described in JIS Z8719-1996. This is regarded as standard external light.

The filter 10 for an electronic display of the present invention is installed on the front side of an electronic display as shown in FIG. 1 to reduce reflected light 13 of external light on the surface of the electronic display without significantly interfering with light emission 12 of the electronic display. As will be apparent from FIG. 1, external light 23 passes twice through the filter 10 for an electronic display. That is, external light 23 is weakened twice in total by the filter 10 for an electronic display.

The filter 10 for an electronic display of the present invention has a minimum value K of transmittance at the wavelength of 530-60.0 nm as shown by the transmittance curve 16 in FIG. 2, which means that light beams in this wavelength range are cut. The “minimum C value” herein used has the same meaning as used with a graph of quadratic function, i.e. refers to a turning point where the value changes from reduction to increase on the graph. It does not mean the smallest value.

As is apparent from the emission spectrum 14 shown in FIG. 2, emission of the plasma display is weak in the wavelength range of 530-600 nm, while as is apparent from the emission spectrum 15, emission of an ordinary fluorescent lamp F6 as unnecessary external light is strong in the range. By cutting light beams in this range, it is possible to effectively cut unnecessary components of external light without unduly weakening emission from the plasma display. That is, it is possible to reduce components of external light reflected on the surface of the display, and to make black portions on the screen blacker. This improves the contrast of the display.

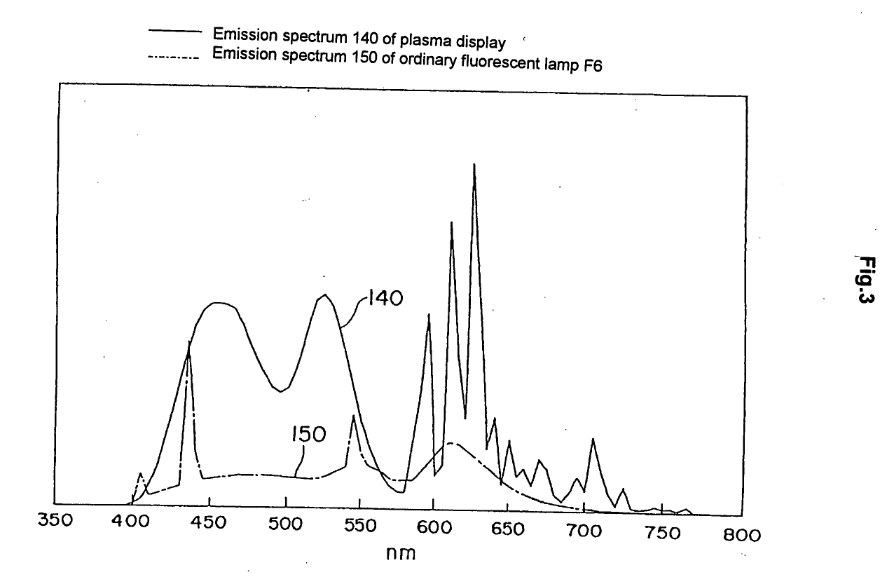

FIG. 3 shows the emission spectrum (emission spectrum 140) of a plasma display after passing the filter for an electronic display of the present invention which solves the first problem, and the emission spectrum (emission spectrum 150) of external light (ordinary fluorescent lamp F6). It is apparent from FIG. 3 that external light has markedly decreased compared with emissions of plasma display. In FIG. 3, external light was passed twice through the filter.

That is, as is apparent from FIG. 1, external light 23 turns to light beams 13 after unnecessary components have been cut by passing through the filter 10 for an electronic display. The light beams 13 are reflected by the plasma display 11 and again pass through the filter 10 for an electronic display, when unnecessary components are cut again into light beams 3.

If the minimum transmittance of the filter for an electronic display is located on the short wavelength side of the 530 nm point (left-hand wavelength range of the wavelength 530 nm in FIG. 2), since the external light components are small in amount in this range, the effect of cutting external light is small. Also, it interferes with the emission of green from the plasma display (absorbs green) (near point G on the emission spectrum 14), thus lowering the effect of contrast improvement. This is not preferable. Also, if the minimum transmittance is on the long wavelength side of the 600 nm point (right-hand wavelength range of the wavelength 600 nm in FIG. 2), it interferes with (absorbs) red emission from the display (near points R1 and R2 on the emission spectrum 14). This is not preferable.

In order to ensure brightness of emission of the display, the transmittance spectrum 16 of the filter for an electronic display, which has a minimum value K in the wavelength range of 530-600 nm, is preferably sharp (steep) valley-shaped. Since a plasma display has strong emissions near the wavelength of 595 nm, if emissions in the range of 530-600 nm are cut, emissions of the plasma display in this wavelength range will weaken, so that the contrast decreases. But since emissions in this range are components that interfere with emissions intrinsically originating from the plasma display by emission of Ne gas, emission components in this range should preferably be cut.

By providing a reflection-preventive layer and/or an anti-glare layer on the surface of the filter for an electronic display of the present invention to prevent external light falling on, the effect of contrast improvement will further increase.

If a compound having absorption in this wavelength range is used to provide the minimum value K of transmittance in the wavelength range of 530-600 nm, the use of a squarylium compound expressed by the formula (IA) is preferable. Suitable squarylium compounds are shown (below:

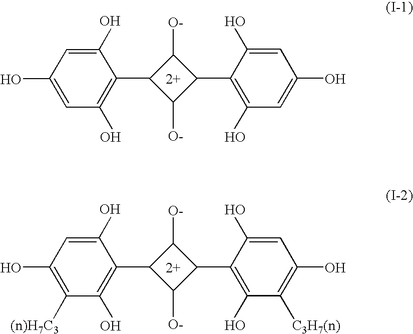

The filter for an electronic display of the present invention that solves the first problem contains such a squarylium compound singly or in the form of a mixture. Typically, it may be contained in the form of a laminate in which on a sheet-like or film-like transparent substrate, a squarylium compound containing resin layer is formed by a binder resin containing a squarylium compound described above, or in the form of a single-layer sheet or film of a squarylium compound-containing resin comprising a binder resin itself which contains a squarylium compound described above.

If a plurality of squarylium compounds are contained, they are preferably separately mixed into binder resins, and the binder resins each containing a squarylium compound are laminated so that each compound will be present in one layer.

On the other hand, the filter for an electronic display is preferably not colored unnaturally. That is, it is preferably colored natural gray or natural blue. Thus, in order to provide a natural gray or natural blue filter while effectively cutting unnecessary external light without inhibiting emissions of blue color (near point B of the emission spectrum 14) and green color (near point G of the emission spectrum 14) of the electronic display, minimum values of transmittance may be present not only in the 530-600 nm wavelength range but also in the 470-520 nm range, preferably 480-510 nm range. For this purpose, the transmittance in the 380-420 nm wavelength range may be reduced.

With the filter for an electronic display of the present invention which solves the first problem, in case functions required for a filter, such as prevention of reflection, absorption of near infrared rays and absorption of electromagnetic waves are required, if the minimum value K of transmittance in the wavelength range of 530-600 nm is 30% or less, preferably 20% or less, and the luminous transmittance Y1 using the emission spectrum of the electronic display on which it is to be installed is higher than the luminous transmittance Y2 using the emission spectrum of an ordinary fluorescent lamp F6, the effect of improvement in contrast is high.

But in order not to cause a marked drop in the brightness of emissions of the electronic display, the luminous transmittance Y1 should be 35% or over, preferably 40% or over, more preferably 45% or over. The luminous transmittance is defined under JIS Z8105-1982 as the ratio of light beams φ t that pass an object to light beams φ i incident into the object, i.e. φt/φi. It is the average of transmittance in the wavelength range of 380-780 nm in view of the relative spectrophotometric responsiveness (spectrophotometric visual efficiency) relative to the responsiveness to brightness of human visual senses. Since it substantially correlates to brightness that shows relative brightness of an object, the luminous transmittance is used as an index of brightness or darkness of a filter.

In order to further increase the effect of improvement in contrast, it is important that the filter contrast value C represented by

C=(Y1)/(Y2)² (1)

be 2.4 or over, preferably 2.7 or over, more preferably 3.0 or over.

The filter contrast value C indicates how easily the emissions of the electronic display pass the filter by the luminous transmittance Y1 using the emission spectrum of an electronic display, and how difficult the emissions of a fluorescent lamp as unnecessary external light pass the filter by the luminous transmittance Y2 using the emission spectrum of an ordinary fluorescent lamp, and indicates the contrast in a bright place by the ratio of Y1 to Y2. In the equation (1), the luminous transmittance Y2 using the emission spectrum of an ordinary fluorescent lamp F6 is squared because emissions of the fluorescent lamp as external light pass through the filter twice, i.e. first when they enter from outside the electronic display and then after they have been reflected by the surface of the display (FIG. 1).

If the filter contrast value is 2.4 or less, only the effects equivalent to the effects obtained by conventional ND filters (neutral-density filters, i.e. filters of which the transmittance is uniform over the entire visible light range, used to decrease the light amount) or filters similar to ND filters are obtainable. In order to improve the light resistance of the filter for an electronic display of the present invention, an ultraviolet absorbing layer may be provided.

The filter for an electronic display of the present invention may be provided with a near infrared ray cutting layer and/or an electromagnetic wave cutting layer. The near infrared ray cutting layer is provided on the front side of the display to prevent malfunction of a remote controller or malfunction in transmittance type optical communication, caused by near infrared rays radiated from a plasma display. Electromagnetic wave cutting layers may be provided by deposition or sputtering of a metallic oxide, or a mesh by etching of a copper foil or a copper plating layer. It cuts electromagnetic waves radiated from an electronic display.

The filter for an electronic display can be used singly, or may be used in the form of a laminate obtained by laminating it to a transparent glass sheet or a transparent resin sheet. In providing an electronic display or a plasma display panel display device using the filter for an electronic display of the present invention for solving the first problem, any known display device or a commercially available device may be used as a display device without any particular limitation.

Hereinbelow, Examples of the present invention for solving the first problem will be described in detail. But the present invention is not limited to these Examples.

Filter Evaluation Method:

1. Luminous Transmittance (defined by JIS Z8105-1982)

Using the transmittance spectrum of the filter measured by spectrophotometer UV3100 pc made by SHIMADZU Corporation, Y of tristimulus values of XYZ color system was calculated to determine the luminous transmittance. The calculation was carried out by method defined in JIS Z8722-2000.

As the emission spectrum of an electronic display used in the equation (1), the emission spectrum of the plasma display (PDS4221J-H) made by FUJITSU General, as measured by use of a spectral brightness meter made by MINOLTA was used.

2. Visual Evaluation of Contrast

In front of the plasma display made by FUJITSU General, the filter being evaluated was placed, and white color was displayed at the center of the display with nothing displayed therearound (no light emitted from the display). The contrast was visually evaluated in this state. The evaluation was made in a room having a white fluorescent lamp hanging from the ceiling.

### EXAMPLE 1

0.58 wt %/resin content of the compound of the above-described specific example (1-2)(squarylium compound), DME and toluene were mixed and dissolved in a 30 wt % toluene solution of polymethyl methacrylate resin (DIANAL BR-80 made by Mitsubishi Rayon Co., Ltd.), applied to a film made of polyethylene terephthalate (PET film ┌T600E┘ made by Mitsubishi Chemical Polyester Film, 50 μm thick) using a bar coater No. 20 (made by TAIYU KIZAI), and dried to obtain a filter having a coating film having a film thickness of 4.5 μm. This is called filter A.

7.6 wt %/resin content of diimonium near infrared absorbing pigment (a tetrafluoroantimonate of N,N,N′,N′-tetrakis(p-dibutylaminophenyl)-p-phenylenediimonium), toluene and MEK were mixed and dissolved in a 30 wt % toluene solution of polymethyl methacrylate resin (DIANAL BR-80, made by Mitsubishi Rayon Co., Ltd.), applied to a film made of polyethylene terephthalate (PET film FT600EJ made by Mitsubishi Chemical Polyester Film, 50 μm thick) using a bar coater (made by TAIYU KIZAI), and dried to obtain a film having a coating film. 9.2 wt %/resin content of dithiol nickel complex near infrared absorbing pigment {bis-2,2′-[1,2-di(3-chlorophenyl)ethylenediimine]_{b} enzene thiolate} nickel (II), toluene and THF were mixed and dissolved in a 30 wt % toluene solution of polymethyl methacrylate resin (DIANAL BR-80, made by Mitsubishi Rayon Co., Ltd.), applied to the other side of the above film in the same manner as above to obtain a filter. This filter, the filter A, an electromagnetic wave shield mesh (wire width 10 micrometers, wire pitch 250 micrometers) and glass were laminated one on another, and further a reflection-preventive film (REALOOK 1200 made by NOF Corporation) was laminated by an adhesive to which was added a UV absorber. By doing so, a filter for an electronic display was obtained.

The filter obtained was evaluated for the minimum transmittance and its wavelength position in the wavelength range of 550-600 nm, the luminous transmittance Y1 using the emission spectrum of a plasma display, luminous transmittance Y2 using the emission spectrum of an ordinary fluorescent lamp F6, and the filter contrast C. The evaluation results are shown in Table 1.

### EXAMPLE 2

Except that instead of the compound of the specific example (I-2; squarylium compound), 0.23 wt %/resin content of the compound of the specific example (I-1; squarylium compound) was added, a filter for an electronic display was obtained in the same manner as in Example 1.

The filter obtained was evaluated for the minimum transmittance and its wavelength position in the wavelength range of the wavelength of 550-600 nm, the luminous transmittance Y1 using the emission spectrum of a plasma display, the luminous transmittance Y2 using the emission spectrum of an ordinary fluorescent lamp F6, and the filter contrast value C. The evaluation results are shown in Table 1.

### COMPARATIVE EXAMPLE 1

Except that the compound of the specific example (I-2) was not added, a filter for an electronic display was obtained in the same manner as in Example 1.

The filter obtained was evaluated for the minimum transmittance and its wavelength position in the wavelength range of the wavelength of 550-600 nm, the luminous transmittance Y1 using the emission spectrum of a plasma display, the luminous transmittance Y2 using the emission spectrum of an ordinary fluorescent lamp F6, and the filter contrast value C. The evaluation results are shown in Table 1.

### COMPARATIVE EXAMPLE 2

Except that the compound of the specific example (I-2; squarylium compound) was added in the amount of 0.24 wt %/resin content, a filter for an electronic display was obtained in the same manner as in Example 1.

The filter obtained was evaluated for the minimum transmittance and its wavelength position in the wavelength range of the wavelength of 550-600 nm of the filter obtained, the luminous transmittance Y1 using the emission spectrum of a plasma display, the luminous transmittance Y2 using the emission spectrum of an ordinary fluorescent lamp F6, and the filter contrast value C. The evaluation results are shown in Table 1.

Visual Evaluation of Contrast

Both in Examples 1 and 2, the contrast was felt high. In Comparative Example 1, while the display emission was strong, external light was strongly reflected at a portion which was not emitting light, so that black turned whitish. The contrast was thus felt lowest. While Comparative Example 2 was relatively strong in the display emission, the reflection of external light was strong, the contrast was felt low.

TABLE 1

| | | Minimum | Luminous | Luminous | Filter |
|---|---|---|---|---|---|
| | | transmission | transmittance | transmittance | contrast |
| | Contrast | position | Y1 (%) | Y2 (%) | value (C) |
| Ex. 1 | ◯ | 580 nm | 43.5 | 36.1 | 3.1 |
| Ex. 2 | ◯ | 570 nm | 48.5 | 40.8 | 2.7 |
| Comp. | X | Nil | 62.8 | 64.1 | 1.6 |
| Ex. 1 | | | | | |
| Comp. | Δ | 580 nm | 53.4 | 49.7 | 2.3 |
| Ex. 2 | | | | | |

Next, the embodiment of the present invention which solves the second problem will be described below in detail.

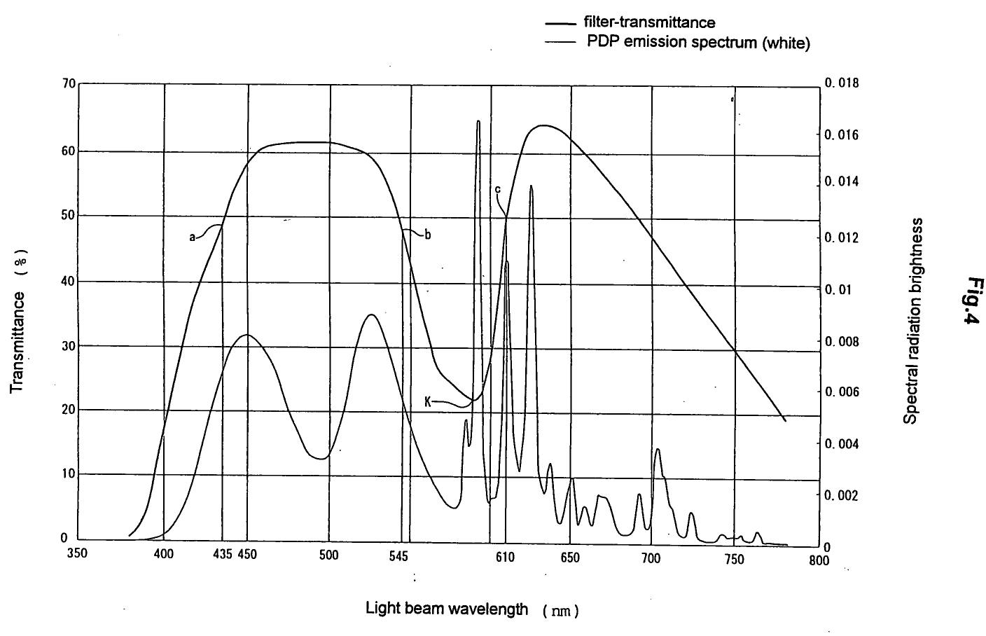

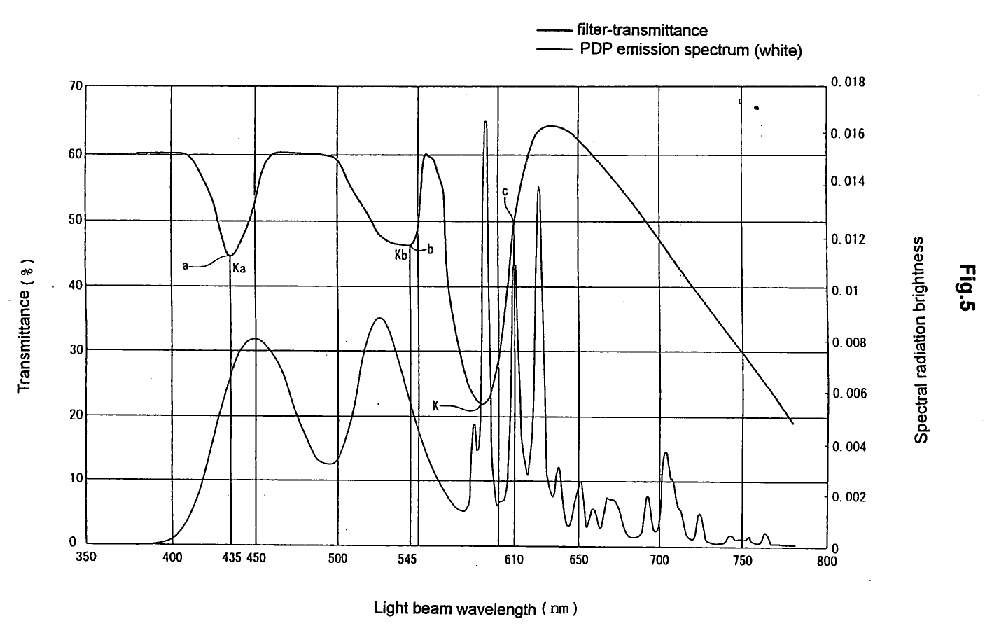

FIGS. 4 and 5 are graphs showing the transmittance spectrum of the filter of the present invention which solves the second problem. The abscissa axis indicates wavelength and the ordinates axis indicates the transmittance (%) for each wavelength. The graph shows the emission spectrum of a plasma display.

The filter of the present invention that solves the second problem, shown in FIG. 4, has one minimum value K of transmittance in the wavelength range of 530-600 nm.

The fact that it has a minimum value K of transmittance in the 530-600 nm wavelength range means that light beams in this wavelength range are cut. The wavelength range of 530-600 nm is an orange light emitting portion between green color emission and red color emission. By cutting this portion, it is possible to obtain brilliant red color display. Thus it is possible to further increase the color temperature and to obtain images having more preferable color tone. If the minimum transmittance is on the short wavelength side of the 530 nm point, the effect of cutting neon emissions is low and the effect of increasing the color temperature is low. If the minimum transmittance is on the long wavelength side of the 600 nm point, emission of red color of the display will be impaired (absorbed). This is not preferable.

In order to improve the color purity of red color emission and to ensure the brightness of the visual field, the transmittance spectrum having a minimum value in the 530-600 nm wavelength range is preferably sharp (steep) valley-shaped.

In the Example of FIG. 4, as described above, a minimum value K of transmittance is provided in the 530-600 nm wavelength range to cut neon emissions. Due to the presence of the minimum value K, the value c of transmittance (%) at 610 nm is around 50%.

In the present invention that solve the second problem, the value c of transmittance (%) at 610 nm, and the values a and b of transmittance at 435 nm and 545 nm are made substantially equal to one another to keep the balance of the transmittance spectrum of external light. That is, they are restricted such that the difference between the maximum value and the minimum value among the values a, b and c of transmittance (%) at 610, 435, 545 nm are 10% or under. Namely, relative to the valve C. the values a and b are adjusted such that |c-a|≦10(%), |c-b|≦|c 10(%) and |a-b|≦10(%).

The filter shown in FIG. 5 has a minimum value K of transmittance in the 530-600 nm range to cut neon emissions. In order to make the value c of transmittance (%) at 610 nm equal to the values a and b of transmittance (%) at 435 nm and 545 nm, it has minimum values Ka and Kb near 435 nm and 545 nm such that the values a and bare made substantially near 50% so as to satisfy the relations |c-a|≦(10%), |c-b|≦10(%), |a-b|≦10(%) relative to the transmittance c (%) at 610 nm to prevent the filter for an electronic display itself from being unnaturally colored. That is, since the color of the filter for an electronic display itself is preferably natural gray or natural blue, for the purpose of providing a filter that will not impair emissions of blue color and green color and is natural gray or natural green, in addition to in the wavelength range of 530-600 nm, the filter has minimum values Ka and Kb near 435 nm and 545 nm as well.

With the filter for an electronic display of the present invention that solves the second problem, the transmittances at these wavelengths can be made substantially equal by containing compounds having maximum absorption near one of wavelengths 435 nm, 545 nm and 610 nm.

Compounds usable for this purpose are not specifically limited so long as in adjusting the absorption of light at 435 nm, 545 nm and 610 nm, they have maximum absorption near these wavelengths.

Compounds having maximum absorption near 435 nm include compounds expressed by the following formula (IV).

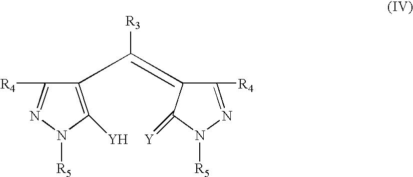

[wherein R₃ is an alkyl group which may have a substituent, a cycloalkyl group which may have a substituent, an aryl group which may have a substituent, or a hydrogen atom, R₄ is an alkyl group which may have a substituent, an alkoxy group which may have a substituent, an alkoxy-carbonyl group which may have a substituent, a cycloalkyl group which may have a substituent, an aryl group which may have a substituent, an aryloxy group which may have a substituent, an aryloxy carbonyl group which may have a substituent, an amino group which may have a substituent, or a hydrogen atom, R⁵ is an alkyl group which may have a substituent, a cycloalkyl group which may have a substituent, an aryl group which may have a substituent, or a hydrogen atom, and Y is an oxygen atom or an imino group. R₄, R₅ and Y may be different in each of pyrazole rings.]

The alkyl groups of R₃ and R₅ in the formula (IV) may be straight chain ones or branched chain ones of which carbon numbers are 1-20, such as methyl groups, ethyl groups, propyl groups, butyl groups, pentyl groups, hexyl groups, heptyl groups, octyl groups, decyl groups, undecyl groups, dodecyl groups, tridecyl groups, and pentadecyl groups. The cycloalkyl groups of R₃ and R₅ may be ones of which carbon numbers are 1-20, such as cyclopropyl groups, cyclobutyl groups, cyclopentyl groups, cyclohexyl groups and cycloheptyl groups. The aryl groups of R₃ and R₅ may be phenyl groups or naphtyl groups.

Substituents of the alkyl groups, cycloalkyl groups and aryl groups may be alkyl groups of which the carbon number is 1-10, such as methyl groups, ethyl groups, propyl groups, butyl groups, pentyl groups, hexyl groups, heptyl groups, octyl groups and decyl groups; alkoxy groups of which the carbon number is 1-10, such as methoxy groups, ethoxy groups, propoxy groups, butoxy groups, pentyloxy groups, hexyloxy groups, heptyloxy groups, octyloxy groups and decyloxy groups; aryl groups such as phenyl groups and naphthyl groups; aryloxy groups such as phenoxy groups and naphthyloxy groups; sulfoneamide groups, alkylsulfoneamide groups, dialkylsulfoneamide groups, nitro groups, hydroxy groups, or halogen atoms such as fluorine atoms, chlorine atoms and bromine atoms.

R₃ and R₅ in the formula (IV) are preferably, among the above-mentioned, (1) straight-chain or branched-chain alkyl groups which may have as substituents alkoxy groups, aryl groups, aryloxy groups, hydroxy groups, or halogen atoms, (2) aryl groups which may have as substituents alkyl groups, alkoxy groups, sulfoneamide groups, alkylsulfoneamide groups, dialkylsulfoneamide groups, nitro groups, hydroxy groups or halogen atoms, or (3) hydrogen atoms. In particular, as R₃, hydrogen atoms, straight-chain or branched-chain alkyl groups of which the carbon number is 1-8, or phenyl groups are preferable. As R₅, straight-chain or branched-chain alkyl groups of which the carbon number is 1-8, or phenyl groups which may have as a substituent alkyl groups or halogen atoms.

The alkyl group of R₄ in the formula (IV) may be any of the alkyl groups mentioned above for R₃ and R₅. The alkoxy group of R₄ may be a straight chain or a branched chain group of which the carbon number is 1-20, such as methoxy groups, ethoxy groups, propoxy groups, butoxy groups, pentyloxy groups, hexyloxy groups, heptyloxy groups, octyloxy groups, decyloxy groups, undecyloxy groups, dodecyloxy groups, tridecyloxy groups or pentadecyloxy groups. The alkoxycarbonyl group of R₄ may be carbonyl groups having alkoxy groups mentioned above, and cycloalkyl groups of R₄ may be any of the cycloalkyl groups mentioned for R₃ and R₅. The aryl group of R₄ may be any of the aryl groups mentioned for R₃ and R₅. The aryloxy group of R₄ may be phonoxy group or naphthyloxy group. The aryloxycarbonyl group of R₄ may be a carbonyl group having an aryloxy group.

Substitutes for alkyl, alkoxy, alkoxycarbonyl, cycloalkyl, aryl, aryloxy, aryloxycarbonyl and amino groups may be alkyl groups, alkoxy groups, aryl groups, aryloxy groups, sulfoneamide groups, alkylsulfoneamide groups, dialkylsulfoneamide groups, nitro groups, halogen atoms, mentioned above as substituents for alkyl groups, cycloalkyl groups and aryl groups for R₃ and R₅, acyl groups such as propionyl groups, butyryl groups or benzoyl groups, sulfonyl groups such as methanesulfonyl groups or benzenesulfonyl groups, hydroxy groups or halogen atoms.

R₄ in the formula (IV) is preferably, among the above mentioned, (1) straight-chain or branched-chain alkyl groups which may have as substituents alkoxy groups, aryl groups, aryloxy groups, hydroxy groups or halogen atoms, (2) straight-chain or branched-chain alkoxy groups which may have as substituents alkoxy groups, (3) carbonyl groups having alkoxy groups which may have as substituents alkoxy groups, (4) aryl groups which may have as substituents alkyl groups, alkoxy groups, sulfoneamide groups, alkylsuslfoneamide groups, dialkylsulfoneamide groups, nitro groups, hydroxy groups or halogen atoms, (5) carbonyl groups having aryl groups which may have as substituents alkyl groups or alkoxy groups, or (6) amino groups which may have as substituents alkyl groups, acyl groups or sulfonyl groups. In particular, straight-chain or branched chain alkyl groups of which the carbon number is 1-8 is preferable.

In the formula (IV), Y is preferably an oxygen atom. In the present invention, in the dipyrazolylmetin compound expressed by the formula (IV), pyrazol rings R₄, R₅ and Y may be different. But they are preferably symmetical with respect to the metin group.

As the compound having maximum absorption near 435 nm, among the compounds expressed by formula (IV), one in which Y is an oxygen atom, R₃ is a hydrogen atom, R₄ and R₅ are alkyl groups which may have substituents or aryl groups which may have substituents is particularly preferable.

Such preferable examples are shown below.

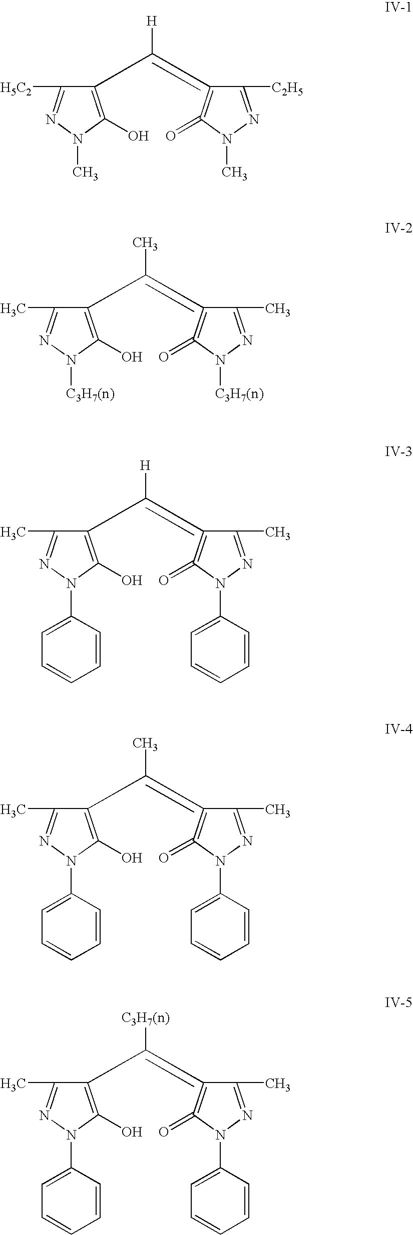

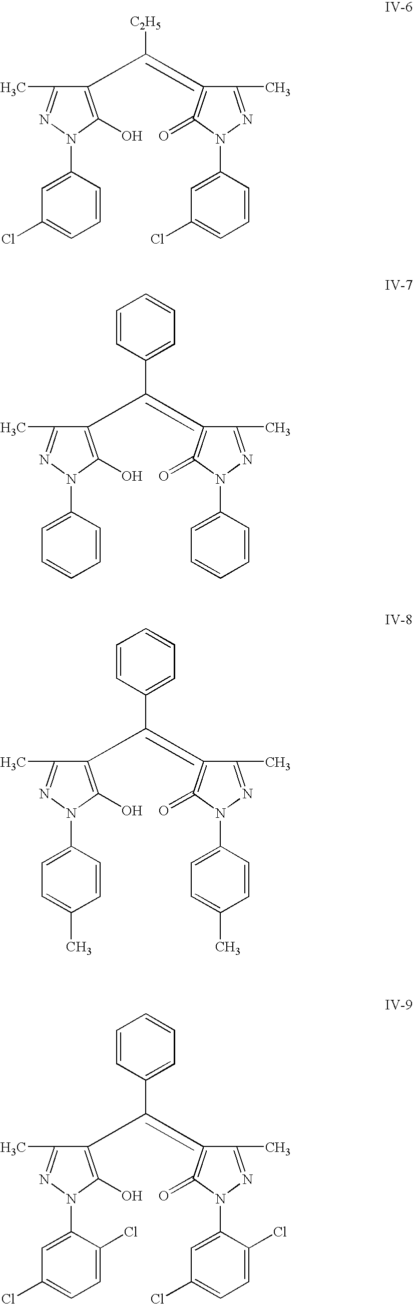

The compound having maximum absorption near 545 nm may be a compound expressed by the following formula (I):

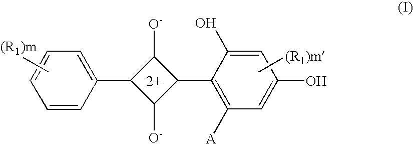

[wherein R₁ is an alkyl group which may have a substituent, or an alkoxy group which may have a substituent, the substituent A is a hydroxy group or W—X—R₂ (wherein W is an imino group or an alkylimino group, X is a carbonyl group or a sulfonyl group, R₂ is an alkyl group which may have a substituent, an alkenyl group which may have a substituent, an aryle which may have a substituent, or a heterocyclic group which may have a substituent) and m=0 or an integer 1-4, and m′=0 or 1.

The alkyl group of R₁ in the formula (I) may be a straight chain or branched chain alkyl group of which carbon number is 1-20, such as methyl groups, ethyl groups, propyl groups, butyl groups, pentyl groups, hexyl groups, heptyl groups, octyl groups, decyl groups, undecyl groups, dodecyl groups, tridecyl groups, and pentadecyl groups. The alkoxy group of R₁ may be a straight chain or branched chain one of which the carbon number is 1-20, such as methoxy groups, ethoxy groups, propoxy groups, butoxy groups, pentyloxy groups, hexyloxy groups, heptyloxy groups, octyloxy groups and decyloxy groups, undecyloxy groups, dodecyloxy groups, tridecyloxy groups, and pentadecyloxy groups.

Substituents for the alkyl groups and alkoxy groups may be alkyl groups of which the carbon number is 1-10, such as methyl groups, ethyl groups, propyl groups, butyl groups, pentyl groups, hexyl groups, heptyl groups, octyl groups and decyl groups, alkoxy groups of which the carbon number is 1-10, such as methoxy groups, ethoxy groups, propoxy groups, butoxy groups, pentyloxy groups, hexyloxy groups, heptyloxy groups, octyloxy groups and decyloxy groups, cycloalkyl groups of which the carbon number is 1-10, such as cyclopropyl groups, cyclobutyl groups, cyclopentyl groups, cyclohexyl groups or cycloheptyl groups, aryl groups such as phenyl groups, hydroxy groups, or halogen atoms such as fluorine atoms, chlorine atoms and bromine atoms.

In the formula (I), preferable as R₁ are, among the above mentioned, (1) a straight-chain or branched-chain alkyl group which may have an alkoxy group, hydroxy group or halogen atoms as a substituent, and particularly preferably a straight-chain or branched-chain alkyl group of which the carbon number is 1-8, or a straight-chain or branched-chain alkoxy group of which the carbon number is 1-8.

The alkyl group in the alkylimino group of W in W—X—R₂ in the formula (I) is preferably a straight chain or branched chain one of which the carbon number is 1-8. W is preferably an imino group or an alkylimino group, and the former is particularly preferable. If X is a sulfonyl group, R₂ is not a hydrogen atom.

The alkyl group of R₂ in W—X—R₂ may be alkyl groups mentioned above as the alkyl groups for R₁, an alkenyl group such as a vinyl group, an aryl group such as phenyl group and naphtyl group, or a heterocyclic group such as 3-pyridyl group, 2-furil group, 2-tetrahydro furil group or 2-thienyl group. These alkyl group, alkenyl group, aryl group and heterocyclic group may have as substituents alkyl groups of which the carbon number is 1-10, alkoxy groups of which the carbon number is 1-10, and cycloalkyl groups of which the carbon number is 1-10, as mentioned above as substituents for the alkyl group and alkoxy group for R₁, or halogen atoms, aryl groups, etc.

Among such R₂s, the same alkyl group as the preferable group for R₁, a phenyl group which may be replaced with an alkyl group of which the carbon number is 1-8, or a vinyl group which may be replaced with an alkyl group of which the carbon number is 1-8 are particularly preferable.

Preferable specific examples are shown below.

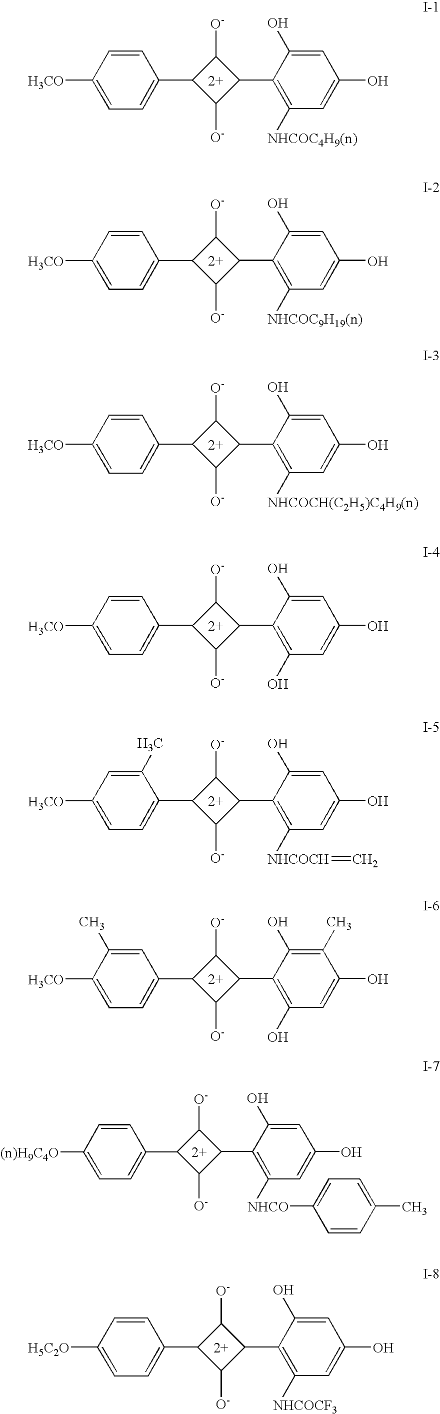

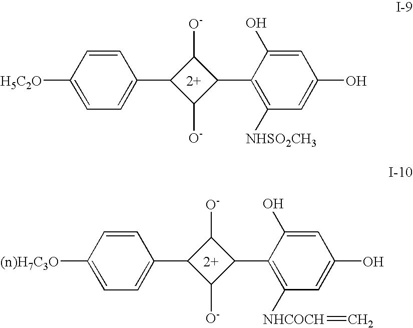

The compound having the maximum absorption near 545 nm may be a compound expressed by the following formula (II).

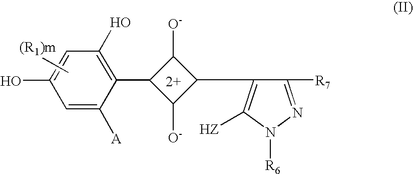

[wherein R₁ is an alkyl group which may have a substituent, or an alkoxy group which may have a substituent, the substituent A is a hydroxy group or W—X—R₂ (wherein W is an imino group, X is a carbonyl group or a sulfonyl group, R₂ is a hydrogen atom, an alkyl group which may have a substituent, an alkenyl group which may have a substituent, an aryl group which may have a substituent, or a heterocyclic group which may have a substituent) m is 0 or 1, R₆ and R₇ are alkyl groups which may have a substituent, or aryl groups which may have a substituent, and Z is an oxygen atom.)

The alkyl group of R₁ in the formula (II) may be a straight chain or branched chain one of which carbon number is 1-20, such as methyl groups, ethyl groups, propyl groups, butyl groups, pentyl groups, hexyl groups, heptyl groups, octyl groups, decyl groups, undecyl groups, dodecyl groups, tridecyl groups, and pentadecyl groups. The alkoxy group of R₁ may be a straight chain or branched chain one of which the carbon number is 1-20, such as methoxy groups, ethoxy groups, propoxy groups, butoxy groups, pentyloxy groups, hexyloxy groups, heptyloxy groups, octyloxy groups, decyloxy groups, undecyloxy groups, dodecyloxy groups, tridecyloxy groups, and pentadecyloxy groups.

Substituents for the alkyl groups and alkoxy groups may be alkyl groups of which the carbon number is 1-10, such as methyl groups, ethyl groups, propyl groups, butyl groups, pentyl groups, hexyl groups, heptyl groups, octyl groups and decyl groups, alkoxy groups of which the carbon number is 1-10, such as methoxy groups, ethoxy groups, propoxy groups, butoxy groups, pentyloxy groups, hexyloxy groups, heptyloxy groups, octyloxy groups and decyloxy groups, cycloalkyl groups of which the carbon number is 1-10, such as cyclopropyl groups, cyclobutyl groups, cyclopentyl groups, cyclohexyl groups or cycloheptyl groups, aryl groups such as phenyl groups, hydroxy groups, or halogen atoms such as fluorine atoms, chlorine atoms and bromine atoms.

In the formula (II), preferable as R₁ are, among the above, (1) a straight-chain or branched-chain alkyl group which may have an alkoxy group, hydroxy group or halogen atoms as a substituent, and particularly preferably a straight-chain or branched-chain alkyl group of which the carbon number is 1-8.

The alkyl group in the alkylimino group of W in W—X—R₂ in the formula (II) is preferably a straight chain or branched chain one of which the carbon number is 1-8. W is preferably an imino group or an alkylimino group, and the former is particularly preferable. If X is a sulfonyl group, R₂ is not a hydrogen atom.

The alkyl group of R₂ in W—X—R₂ may be alkyl groups mentioned above as the alkyl groups for R₁, an alkenyl group such as a vinyl group, an aryl group such as phenyl group or naphthyl group, or a heterocyclic group such as 3-pyridyl group, 2-furil group, 2-tetrahydro furil group or 2-thienyl group. These alkyl group, alkenyl group, aryl group and heterocyclic group may have as substituents alkyl groups of which the carbon number is 1-10, alkoxy groups of which the carbon number is 1-10, and cycloalkyl groups of which the carbon number is 1-10, as mentioned as substituents for the alkyl group and alkoxy group in R₁, or halogen atoms, aryl groups, etc.

Among such R₂S, the same alkyl group as the preferable group of R₁, a phenyl group which may be replaced with an alkyl group of which the carbon number is 1-8 is particularly preferable.

The alkyl group of R₆ and R₇ which may have a substituent and the aryl group which may have a substituent may be an alkyl group which may have a substituent or an aryl group which may have a substituent as mentioned with respect to R₂.

Among these R₆s and R₇s, the same alkyl groups or aryl groups as in R₂ are especially preferable.

Preferable specific examples are shown below:

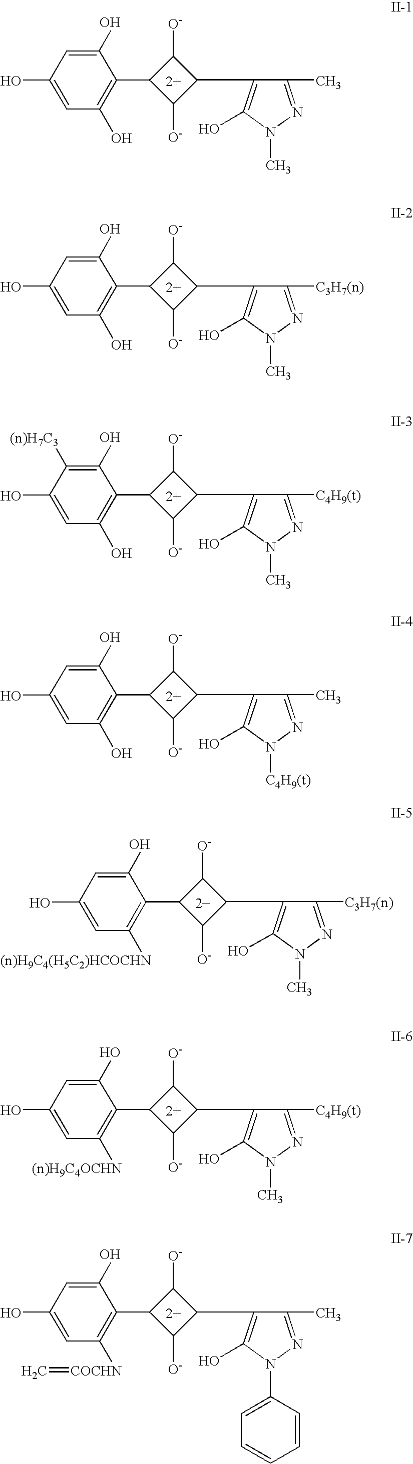

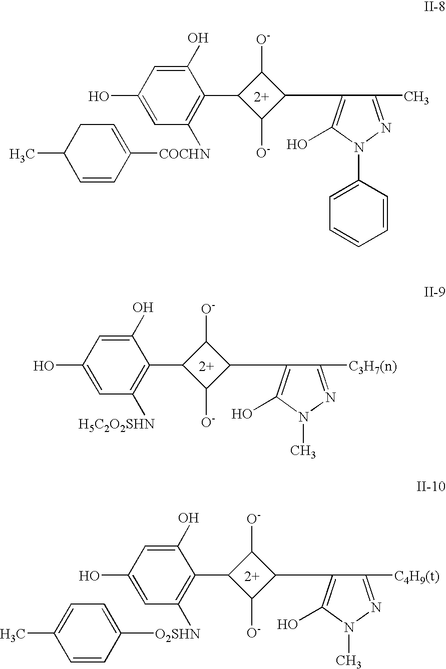

The compound having maximum absorption near 610 nm may be compounds expressed by the following formula (III).

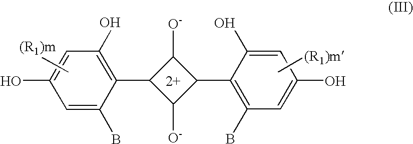

[wherein R₁ is an alkyl group which may have a substituent, or an alkoxy group which may have a substituent, the substituent B is W—CO—R₂ (wherein W is an imino group or an alkylimino group, R₂ is an alkenyl group which may have a substituent or an alkynyl group which may have a substituent, and m and m′ are 0 or 1 and independent from each other)]

The alkyl group of R₁ in the formula (III) may be a straight chain or branched chain one of which carbon number is 1-20, such as methyl groups, ethyl groups, propyl groups, butyl groups, pentyl groups, hexyl groups, heptyl groups, octyl groups, decyl groups, undecyl groups, dodecyl groups, tridecyl groups, and pentadecyl groups. The alkoxy group of R₁ may be a straight chain or branched chain one of which the carbon number is 1-20, such as methoxy groups, ethoxy groups, propoxy groups, butoxy groups, pentyloxy groups, hexyloxy groups, heptyloxy groups, octyloxy groups, decyloxy groups, undecyloxy groups, dodecyloxy groups, tridecyloxy groups, and pentadecyloxy groups.

Substituents for the alkyl groups and alkoxy groups may be alkyl groups of which the carbon number is 1-10, such as methyl groups, ethyl groups, propyl groups, butyl groups, pentyl groups, hexyl groups, heptyl groups, octyl groups and decyl groups, alkoxy groups of which the carbon number is 1-10, such as methoxy groups, ethoxy groups, propoxy groups, butoxy groups, pentyloxy groups, hexyloxy groups, heptyloxy groups, octyloxy groups and decyloxy groups, cycloalkyl groups of which the carbon number is 1-10, such as cyclopropyl groups, cyclobutyl groups, cyclopentyl groups, cyclohexyl groups or cycloheptyl groups, aryl groups such as phenyl groups, hydroxy groups, or halogen atoms such as fluorine atoms, chlorine atoms and bromine atoms.

In the formula (III), R₁ is preferably, among the above, (1) a straight-chain or branched-chain alkyl group which may have an alkoxy group, hydroxy group or halogen atoms as a substituent, and particularly preferably a straight-chain or branched-chain alkyl group of which the carbon number is 1-8, or a straight-chain or branched-chain alkoxy group of which the carbon number is 1-8.

The alkyl group in the alkylimino group of W in W—CO—R₂ in the formula (III) is preferably a straight chain or branched chain one of which the carbon number is 1-8. W is preferably an imino group or an alkylimino group, and an imino group is particularly preferable.

R₂ in W—X—R₂ may be an alkenyl group such as a vinyl group or an alkynyl group such as acetylene′ group. These alkenyl and alkynyl groups may have, as a substituent, the alkyl group of R₁, the alkyl groups of which the carbon number is 1-10, alkoxy groups of which the carbon number is 1-10, or cycloalkyl groups of which the carbon number is 1-10, which have been cited as substituents for alkoxy groups, or halogen atoms, or an aryl group.

Among these R₂s, an alkyl group of which the carbon number is 1-8 or a vinyl group which may be replaced with a phenyl group is particularly preferable.

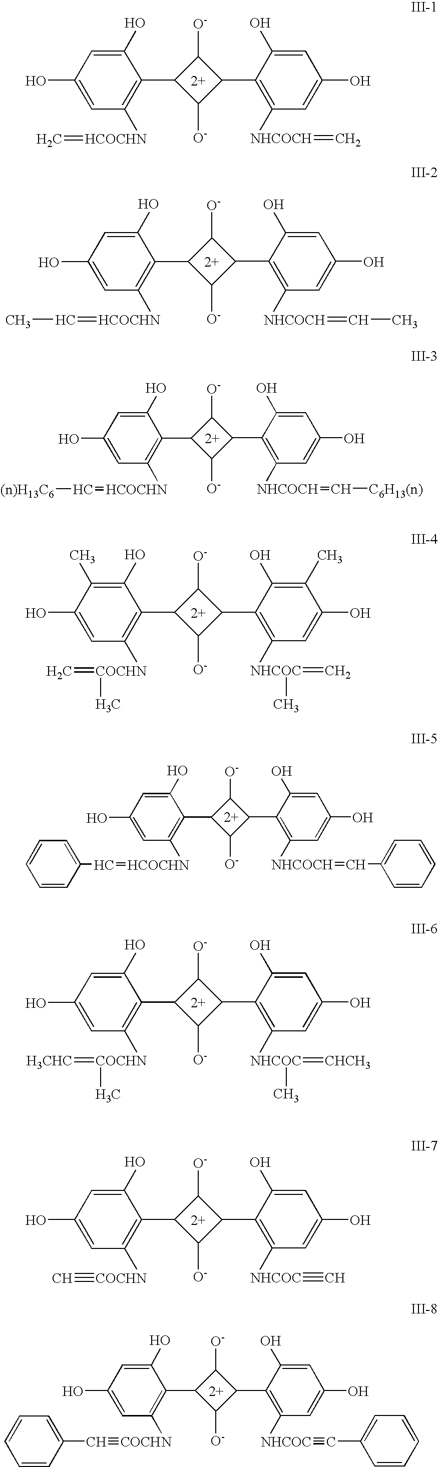

Also, in the filter for an electronic display of the present invention which solves the second problem, it is preferable that a compound having maximum absorption near 530-600 nm coexists. Besides the above compounds expressed by the formulas (IV), (I), (II) and (III), compounds of the following formulas (V)-(XI) can be cited.

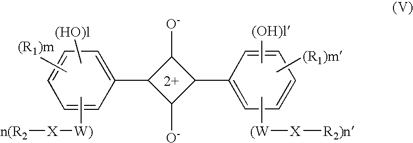

[wherein R₁ is an alkyl group which may have a substituent, an alkoxy group which may have a substituent, a cycloalkyl group which may have a substituent, an aryl group which may have a substituent, an aryloxy group which may have a substituent, or a halogen atom, W in W—X—R₂ is an imino group, an alkylimino group or an oxygen atom, x is a carbonyl group or a sulfonyl group, R₂ is a monohydric group or a hydrogen atom, 1 and 1′ are independent integers of 0-5, m and m′ are independent integers of 0-5, n and n′ are independent integers of 0-3, 1+m+n≦5, 1′+m′+n′≦5, if a plurality of R₁ and W—X—R₂ exist on benzene rings, they may differ from each other in one benzene ring or between the benzene rings.]

The alkyl group of R₁ in the formula (V) may be a straight chain or branched chain one of which carbon number is 1-20, such as methyl groups, ethyl groups, propyl groups, butyl groups, pentyl groups, hexyl groups, heptyl groups, octyl groups, decyl groups, undecyl groups, dodecyl groups, tridecyl groups, and pentadecyl groups. The alkoxy group of R₁ may be a straight chain or branched chain one of which the carbon number is 1-20, such as methoxy groups, ethoxy groups, propoxy groups, butoxy groups, pentyloxy groups, hexyloxy groups, heptyloxy groups, octyloxy groups, decyloxy groups, undecyloxy groups, dodecyloxy groups, tridecyloxy groups, and pentadecyloxy groups. The cycloalkyl group of R₁ may have the carbon number of 1-20, such as a cyclopropyl group, cyclobutyl group, cyclopentyl group, cyclohexyl group, and cycloheptyl group. The aryl group of R₁ may be a phenyl group or a naphthyl group. The aryloxy group of R₁ may be a phenoxy group or a naphthyloxy group. The halogen atom of R₁ may be a fluorine atom, chlorine atom or bromine atom.

Substituents for the alkoxy group, cycloalkyl group, aryl group and aryloxy group may be alkyl groups of which the carbon number is 1-10, such as methyl groups, ethyl groups, propyl groups, butyl groups, pentyl groups, hexyl groups, heptyl groups, octyl groups and decyl groups, alkoxy groups of which the carbon number is 1-10, such as methoxy groups, ethoxy groups, propoxy groups, butoxy groups, pentyloxy groups, hexyloxy groups, heptyloxy groups, octyloxy groups and decyloxy groups, cycloalkyl groups of which the carbon number is 1-10, such as cyclopropyl groups, cyclobutyl groups, cyclopentyl groups, cyclohexyl groups or cycloheptyl groups, hydroxy groups, or halogen atoms such as fluorine atoms, chlorine atoms and bromine atoms.

As R₁ in the formula (V), are preferable, among the above, (1) a straight-chain or branched-chain alkyl group which may have as a substituent an alkoxy group, a hydroxy group or a halogen atom, (2) a straight-chain or branched-chain alkoxy group which may have an alkoxy group as a substitute, (3) an aryl group which may have an alkyl group, alkoxy group or halogen atom as a substituent, (4) an aryloxy group which may have an alkyl group, alkoxy group or halogen atom as a substituent, or (5) a halogen atom. A straight-chain or branched-chain alkyl group of which the carbon number is 1-8, and a straight-chain or branched-chain alkoxy group of which the carbon number is 1-8 are particularly preferable.

The alkyl group in the alkylimino group of W in W—X—R₂ in the formula (V) is preferably a straight chain or a branched chain one of which the carbon number is 1-8. W is preferably an imino group or alkylimino group. An imino group is particularly preferable. If X is a sulfonyl group, R₂ is not a hydrogen atom.

The monohydric group of R₂ in W—X—R₂ may be any of the alkyl groups mentioned above as the alkyl group in R₁, any of the alkoxy groups mentioned above as the alkoxy group in R₁, any of the cycloalkyl groups mentioned as the cycloalkyl group in R₁, any of the aryl groups mentioned as the aryl group in R₁, any of the aryloxy groups mentioned as the aryloxy group in R₁, an amino group, or a heterocyclic group such as 3-pyridyl group, 2-furil group, 2-tetrahydrofuril group or 2-thienyl group. The alkyl group, alkoxy group, cycloalkyl group, aryl group, aryloxy group, amine group and heterocyclic group may have as substituents alkyl groups of which the carbon number is 1-10, alkoxy groups of which the carbon number is 1-10, and cycloalkyl groups of which the carbon number is 1-10, as mentioned above as substituents for the alkyl group, alkoxy group, cycloalkyl group, aryl group, and aryloxy group in R₁, or halogen atoms, aryl groups, etc.

Among the above R₂, particularly preferable are the same alkyl groups as those described as preferable for R₁, phenyl groups which may be replaced with an alkyl group having a carbon number of 1-8,2-furyl group which may be replaced with an alkyl group having a carbon number of 1-8,2-tetrahydrofuryl group which may be replaced with an alkyl group having a carbon number of 1-8, and cyclohexyl group which may be replaced with an alkyl group having a carbon number of 1-8.

In the above formula, 1 and 1′ are independent integers from 0 to 5, m and m′ are independent integers of 0-5, n and n′ are independent integers of 0-3, 1+m+n≦5, 1′+m′+n′≦5. Preferably, 1 and 1′ are not less than 1, 1+m+n≦3, 1′+m′+n′≦3. More preferably, m and m′ are 0. If a plurality of R₁ and W—X—R₂ are present on the benzene rings, R₁ 's and W—X—R₂'s may be different from each other in one benzene ring or between the benzene rings. Adjacent R₁'s on one benzene ring may be coupled together to form alcanediyl group or alkylenedioxy group to form a cyclic structure.

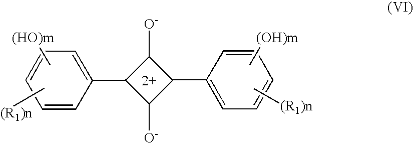

[wherein R₁ is a halogen atom, an alkyl group which may have a substituent, an alkoxyh group which may have a substituent, or an alkenyl group which may have a substituent, m is an integer 1-3, and n is an integer 1-4.]

In the formula (VI), the substituent R₁ may be any of the following (i)-(vii).

(i) Halogen atom such as a fluorine atom, chlorine atom or bromine atom;

(ii) Straight chain or branched chain alkyl group of which the carbon number is 1-20, such as a methyl group, ethyl group, propyl group, butyl group, pentyl group, hexyl group, heptyl group, octyl group, decyl group, undecyl group, dodecyl group, tridecyl group or pentadecyl group.

(iii) Straight chain or branched chain alkyl group of which the carbon number is 1-20 and which has as a substituent an alkykoxycarbonyl group such as a hydroxy group, methoxycarbonyl group, ethoxycarbonyl group or butoxycarbonyl group, an acyloxycarbonyl group such as acetyloxycarbonyl group or propionyloxycarbonyl group, an alkoxycarbonyloxy group such as methoxycarbonyloxy group, ethoxycarbonyloxy group or butoxycarbonyloxy group, a cyclohexyl group or a phenyl group;

(iv) Straight-chain or branched-chain alkoxy group of which the carbon number is 1-20, such as a methoxy group, ethoxy group, propoxy group, butoxy group, pentyloxy group, hexyloxy group, heptyloxy group, octyloxy group, decyloxy group, undecyloxy group, dodecyloxy group, tridecyloxy group or pentadecyloxy group;

(v) Straight-chain or branched chain alkoxy group of which the carbon number is 1-20, having as a substituent an alkoxy group having a carbon number of 1 to 8, such as methoxy group, ethoxy group, propoxy group, butoxy group, pentyloxy group, hexyloxy group, heptyloxy group or octyloxy group;

(vi) Alkenyl group such as ethenyl group; and

(vii) Alkenyl group such as ethenyl group, replaced with an alkyl group such as methyl group, ethyl group, propyl group, butyl group, pentyl group, hexyl group, heptyl group, octyl group or decyl group, or phenyl group, 4-hydroxyphenyl group, 4-alkoxy (e.g. alkoxy group of which the carbon number is 1-10) phenyl group, 3,4-bisalkoxy (e.g. alkoxy group of which the carbon number is 1-10) phenyl group, 3,5-bisalkoxy (e.g. alkoxy group of which the carbon number is 1-10) phenyl group, or 3,4,5-trialkoxy (e.g. alkoxy group of which the carbon number is 1-10) phenyl group.

Among them, R is particularly preferably a straight-chain or branched-chain alkyl group of which the carbon number is 1-6, a straight chain or branched chain alkyl group of which the carbon number is 1-6 and which is replaced with a hydroxy group or alkoxycarbonyl group, an alkoxy group of which the carbon number is 1-6, or an ethenyl having a substituent.

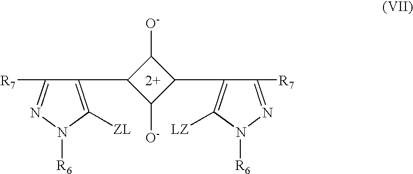

[wherein R₆ is an alkyl group which may have a substituent, a cycloalkyl group which may have a substituent, an aryl group which may have a substituent, or a hydrogen atom, R₇ is an alkyl group which may have a substituent, an alkoxy group which may have a substituent, an alkoxycarbonyl group which may have a substituent, a cycloalkyl group which may have a substituent, an aryl group which may have a substituent, an aryloxy group which may have a substituent, an aryloxycarbonyl group which may have a substituent, an amino group which may have a substituent, a hydroxy group or a hydrogen atom; Z is an imino group or alkylimino group, and L is a hydrogen atom or —XR (wherein R is a monohydric group or a hydrogen atom, and X is a carbonyl group or a sulfonyl group). R₆, R₇, L and Z in each pyrazole ring may be different from those in the other pyrazole ring.

The alkyl group of the substituent R₆ in the formula (VII) may be a straight chain or branched chain one whose carbon number is 1-20, such as methyl group, ethyl group, propyl group, butyl group, pentyl group, hexyl group, heptyl group, octyl group, decyl group, undecyl group, dodecyl group, tridecyl group or pentadecyl group. The cycloalkyl group of R₆ may be one of which the carbon number is 1-20, such as cyclopropyl group, cyclobutyl group, cyclopentyl group, cyclohexyl group or cycloheptyl group. The aryl group of R₆ may be phenyl group or naphthyl groups.

Substituents for the alkyl group, cycloalkyl group and aryl group may be alkyl groups of which the carbon numbers are 1-10, such as methyl group, ethyl group, propyl group, butyl group, pentyl group, hexyl group, heptyl group, octyl group and decyl group, alkoxy groups of which the carbon number is 1-10, such as methoxy group, ethoxy group, propoxy group, butoxy pentyloxy group, hexyloxy group, heptyloxy group, octyloxy group and decyloxy group, aryl groups such as phenyl groups and naphthyl groups, aryloxy groups such as phenoxy groups and naphthyloxy groups, formamino groups, alkylcarbonylamino groups, alkylsulfonylamino groups, aminocarbonyl groups, alkylaminocarbonyl groups, dialkylaminocarbonyl groups, aminosulfonyl groups, alkylaminosulfonyl groups, dialkylaminosulfonyl groups, amino groups, nitro groups, hydroxy groups, and halogen atoms such as fluorine atoms, chlorine atoms or bromine atoms.

As R₆ in the formula (VII), preferable are, among the above, (1) a straight chain or branched-chain alkyl groups which may have as a substituent an alkoxy group, aryl group, aryloxy group, hydroxy group, or halogen atom, or (2) an aryl group which may have as a substituent an alkyl group, alkoxy group, amino group, alkylcarbonylamino group, alkylsulfonylamino group, nitro group, hydroxy group or a halogen atom. A straight chain or branched chain alkyl group of which the carbon number is 1-8 and which may have an alkoxy group as a substituent is particularly preferable.

The alkyl group of R₇ in the formula (VII) may be any of the alkyl groups mentioned above for R₆. The alkoxy group of R₇ may be a straight chain or a branched chain one of which the carbon number is 1-20, such as methoxy group, ethoxy group, propoxy group, butoxy group, pentyloxy group, hexyloxy group, heptyloxy group, octyloxy group, decyloxy group, undecyloxy group, dodecyloxy group, tridecyloxy group or pentadecyloxy group. The alkoxycarbonyl group of R₇ may be a carbonyl group having an alkoxy group. The cycloalkyl group of R₇ may be any of the cycloalkyl groups mentioned for R₆. The aryl group thereof may be any of the aryl groups mentioned for R₆′. The aryloxy group of R₇ may be a phonoxy group or a naphthyloxy group. The aryloxycarbonyl group of R₇ may be a carbonyl group having the abovesaid aryloxy group.

Substituents for the alkyl, alkoxy, alkoxycarbonyl, cycloalkyl, aryl, aryloxy, aryloxycarbonyl and amino groups may be any of the alkyl groups for R₆, cycloalkyl groups, alkyl groups as mentioned as the substituent for aryl groups, alkoxy groups, aryl groups, aryloxy groups of the same, sulfoneamide groups of the same, alkylsulfoneamide groups of the same, dialkylsulfoneamide groups of the same, nitro groups of the same, halogen atoms of the same, acyl groups such as propionyl groups, butyryl groups or benzoyl groups, sulfonyl groups such as methanesulfonyl groups or benzenesulfonyl groups, hydroxy groups or halogen atoms.

As R₇ in the formula (VII), preferable are, among the above, (1) a straight chain or branched chain alkyl group which may have as a substituent an alkoxy group, aryl group, aryloxy group, hydroxy group or halogen atom,

(2) a straight chain or branched chain alkoxy group which may have as a substituent an alkoxy group, (3) a carbonyl group having an alkoxy group which may have as a substituent an alkoxy group, (4) an aryl group which may have as a substituent an alkyl group, alkoxy group, sulfoneamide group, alkylsuslfoneamide group, dialkylsulfoneamide group, nitro group, hydroxy group or halogen atom, (5) a carbonyl group having an aryl group which may have as a substituent an alkyl group or alkoxy group, or (6) an amino group which may have as a substituent an alkyl group, acyl group or sulfonyl group. In particular, a straight-chain or branched chain alkyl group of which the carbon number is 1-8 and which may have an alkoxy group as a substituent is preferable.

The monohydric group of R in —X—R may be any of alkyl, cycloalkyl and alkoxy groups for R₆, an aryloxy group having an aryl group for R₆, an amino group, a heterocyclic group such as 3-pyridyl group, 2-furil group, 2-tetrahydrofuril group or 2-thienyl group, or an alkenyl group such as a vinyl group. The alkyl group in the alkylimino group of Z in the formula (VII) is preferably a straight chain or branched chain of which the carbon number is 1-8. Z is preferably an imino group or alkylimino group, particularly preferably an imino group. If X is a sulfonyl group, R is not a hydrogen atom.

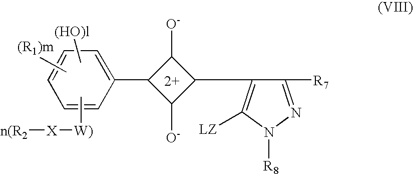

[wherein R₁ is an alkyl group which may have a substituent, an alkoxy group which may have a substituent, a cycloalkyl group which may have a substituent, an aryl group which may have a substituent, an aryloxy group which may have a substituent, or a halogen atom; W is an imino group, an alkylimino group or an oxygen atom; X is a carbonyl group or a sulfonyl group; R₂ is a monohydric group or a hydrogen atom; 1 is an integer 0-5; m is an integer 0-5; n is an integer 0-3, 1+m+n≦5, if a plurality of R₁'s and W—X—R₂'s exist on benzene rings, they may differ from each other in one benzene ring or between the benzene rings. R⁶ is an alkyl group which may have a substituent, an cycloalkyl group which may have a substituent, an aryl group which may have a substituent, or a hydrogen atom; R₇ is an alkyl group which may have a substituent, an alkoxy group which may have a substituent, an alkoxycarbonyl group which may have a substituent, a cycloalkyl group which may have a substituent, an aryl group which may have a substituent, an aryloxy group which may have a substituent, an aryloxycarbonyl group which may have a substituent, an amino group which may have a substituent, a hydroxy group or a hydrogen atom; Z is an oxygen atom, imino group, alkylimino group; L is a hydrogen atom or —XR (wherein R is a monohydric group or a hydrogen atom, X is a carbonyl group or sulfonyl group)]

R₁, R₂, W, X, 1, m, n in the formula (VIII) are the same as those in the formula (V). R₆, R₇, L and Z are the same as those in the formula (VII).

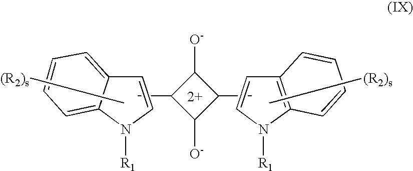

[wherein R₁ is hydroxy group, amino group or an alkyl group which may have a substituent, or an aryl group which may have a substituent, R₂ is an alkyl group which may have a substituent, an alkoxy group which may have a substituent, a cycloalkyl group which may have a substituent, an aryl group which may have a substituent, or a halogen atom, and s is an integer 0-5.]

The alkyl group of R₁ in the formula (IX) may be a straight chain or branched chain one whose carbon number is 1-20, such as methyl group, ethyl group, propyl group, butyl group, pentyl group, hexyl group, heptyl group, octyl group, decyl group, undecyl group, dodecyl group, tridecyl group or pentadecyl group. The aryl group of R₂ may be a phenyl group or naphthyl group.

The alkyl group of R₂ may be any of the alkyl groups for R₁. The aryl group of R₂ may be any of the aryl groups for R₁. The alkoxyy group of R₂ may a straight chain or a branched chain one of which the carbon number is 1-20, such as methoxy group, ethoxy group, propoxy group, butoxy group, pentyloxy group, hexyloxy group, heptyloxy group, octyloxy group, decyloxy group, undecyloxy group, dodecyloxy group, tridecyloxy group or pentadecyloxy group. The cycloalkyl group of R₂ may be one of which the carbon number is 1-20, such as cyclopropyl group, cyclobutyl group, cyclopentyl group, cyclohexyl group or cycloheptyl group. The halogen atom of R₁ may be a fluorine atom, chlorine atom or bromine atom.

Substituents for the alkyl group, alkoxy group, cycloalkyl group and aryl group may be alkyl groups of which the carbon number is 1-10, such as methyl groups, ethyl groups, propyl groups, butyl groups, pentyl groups, hexyl groups, heptyl groups, octyl groups and decyl groups, alkoxy groups of which the carbon number is 1-10, such as methoxy groups, ethoxy groups, propoxy groups, butoxy groups, pentyloxy groups, hexyloxy groups, heptyloxy groups, octyloxy groups and decyloxy groups; cycloalkyl groups of which the carbon number is 1-10, such as alkoxy groups, cyclopropyl groups, cyclobutyl groups, cyclopentyl groups, cyclohexyl groups or cycloheptyl groups; aryl groups such as phenyl groups or naphthyl groups, hydroxy groups, or halogen atoms such as fluorine atoms, chlorine atoms or bromine atoms.

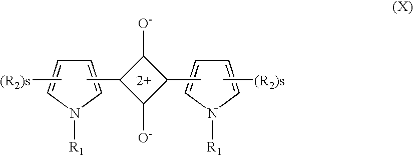

[wherein R₁ is hydroxy group, amino group or an alkyl group which may have a substituent, or an aryl group which may have a substituent, R₂ is an alkyl group which may have a substituent, or an aryl group which may have a substituent. s is an integer 0-3]

The alkyl groups of R₁ and R₂ in the formula (X) may be a straight chain or branched chain one whose carbon number is 1-20, such as methyl group, ethyl group, propyl group, butyl group, pentyl group, hexyl group, heptyl group, octyl group, decyl group, undecyl group, dodecyl group, tridecyl group or pentadecyl group. The aryl groups of R₁ and R₂ may be a phenyl group or naphthyl group.

Substituents for the alkyl group and aryl group may be alkyl groups of which the carbon number is 1-10, such as methyl groups, ethyl groups, propyl groups, butyl groups, pentyl groups, hexyl groups, heptyl groups, octyl groups and decyl groups; alkoxy groups of which the carbon number is 1-10, such as methoxy groups, ethoxy groups, propoxy groups, butoxy groups, pentyloxy groups, hexyloxy groups, heptyloxy groups, octyloxy groups and decyloxy groups; cycloalkyl groups of which the carbon number is 1-10, such as alkoxy groups, cyclopropyl groups, cyclobutyl groups, cyclopentyl groups, cyclohexyl groups or cycloheptyl groups; aryl groups such as phenyl groups or naphthyl groups; hydroxy groups, or halogen atoms such as fluorine atoms, chlorine atoms or bromine atoms.

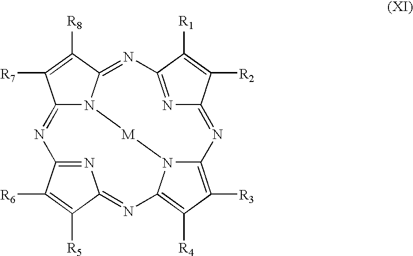

[wherein R₁-R₈ are independently hydrogen atom, halogen atom, nitro group, hydroxy group, amino group or an alkyl group which may have a substituent, an alkoxy group which may have a substituent, an aryl group which may have a substituent, an aryloxy group which may have a substituent, an alkylamino group which may have a substituent, a dialkylamino group which may have a substituent, an alkylthio group which may have a substituent, or an arylthio group which may have a substituent. R₁ and R2, R₃ and R₄, R₅ and R₆, and R₇ and R₈ may be coupled together to form an aliphatic carbon ring. M is two hydrogen atoms, a dihydric metallic atom, a trihydric monosubstituted metallic atom, a tetrahydric disubstituted metallic atom or an oxy metallic atom.]

In the formula (XI), the halogen atom may be a fluorine atom, chlorine atom or bromine atom. The alkyl group may be a straight chain, branched chain or a ring one whose carbon number is 1-20, such as methyl group, ethyl group, propyl group, butyl group, pentyl group, hexyl group, heptyl group, octyl group, decyl group, undecyl group, dodecyl group, tridecyl group, pentadecyl group, cyclopropyl group, cyclobutyl group, cyclopentyl group, cyclohexyl group or cycloheptyl group. The alkoxy group may be a straight chain or branched chain one of which the carbon number is 1-20, such as methoxy group, ethoxy group, propoxy group, butoxy group, pentyloxy group, hexyloxy group, heptyloxy group, octyloxy group and decyloxy group, undecyloxy group, dodecyloxy group, tridecyloxy group or pentadecyloxy group. The aryl group may be a hydrocarbon aryl group such as a phenyl group or naphthyl group, or a heterocyclic aryl group such as a thienyl group, furil group or pyridyl group. The aryloxy group may be a hydrocarbon aryloxy group such as a phenoxy group or naphthyloxy group, or a heterocyclic aryloxy group such as a thienyloxy group, furyloxy group or pyridyl group. The alkylamino group or dialkylamino group may be a straight-chain or branched-chain alkyl group of which the carbon number is 1-20, such as methyl group, ethyl group, propyl group, butyl group, pentyl group, hexyl group, heptyl group, octyl group, decyl group, undecyl group, dodecyl group, tridecyl group or monosubstituted or disubstituted pentadecyl. The alkylthio group may be a straight cahin or branched chain one of which the carbon number is 1-20, such as methylthio group, ethylthio group, propylthio group, butylthio group, pentylthio group, hexylthio group, heptylthio group, octylthio group, decylthio group, undecylthio group, dodecylthio group, tridecylthio group or pentadecylthio group. The arylthio group may be a phenylthio group or a naphthylthio group.

Substituents for the alkyl group, alkoxy group, aryl group, aryloxy group, alkylamino group, dialkylamino group, alkylthio group and arylthio group may be an alkyl group of which the carbon number is 1-10, such as methyl group, ethyl group, propyl group., butyl group, pentyl group, hexyl group, heptyl group, octyl group, decyl group, cyclopropyl group, cyclobutyl group, cyclopentyl group, cyclohexyl group or cycloheptyl group; an alkoxy group of which the carbon number is 1-10, such as methoxy group, ethoxy group, propoxy group, butoxy group, pentyloxy group, hexyloxy group, heptyloxy group, octyloxy group or decyloxy group; a hydroxy group, or a halogen atom such as a fluorine atom, chlorine atom or bromine atom.

R₁ and R₂, R₃ and R₄, R₅ and R₆, and R₇ and R₈ may be coupled together to form aliphatic carbon rings such as —(CH₂)₃—, —(CH₂)ₙ— or —(CH₂)₅—.

In the formula (XI), R₁—R₈ are preferably, among the above, (1) a straight-chain or branched-chain alkyl group which may have an alkoxy group or halogen atom as a substituent, (2) a cycloalkyl group which may have a straight-chain or branched-chain alkyl group as a substituent, (3) an aryl group which may have an alkyl group, alkoxy group or halogen atom as a substituent, (4) a halogen atom, or (5) they are coupled together to form an aliphatic carbon ring, and particularly preferably a straight-chain or branched-chain alkyl group of which the carbon number is 1-8, or they are coupled together to form —(CH₂)₃— or —(CH₂)₄—.

M in the formula (XI) is two hydrogen atoms, or a dihydric metallic atom, a trihydric monosubstituted metallic atom, a tetrahydric disubstituted metallic atom or an oxy metallic atom selected from the elements belonging to group 2, group 3, group 4, group 8, group 9, group 10, group 11, group 12, group 13, group 14 and group 15 of the periodic table based on the 1990 rule of Inorganic Chemical Nomenclature. Specific examples thereof are Cu, Zn, Fe, Co, Ni, Ru, Rd, Pd, Mn, Sn, Mg and Ti for dihydric metallic atoms, halogen atoms such as Al—Cl, Ga-Cl, In—Cl, Fe-Cl, Ru—Cl, and monosubstituted metallic atoms by hydroxy groups or alkoxy groups for trihydric monosubstituted metallic atoms, halogen atoms such as SiCl₂, GeCl₂, TiCl₂, SnCl₂, Si(OH)₂, Ge(OH)₂₁ Mn(OH)₂ or Sn(OH)₂, or monosubstituted metallic atoms by hydroxy groups or alkoxy groups for tetrahydric disubstituted metallic atoms, and VO, MnO and TiO for oxy metals. Among them, VO, Cu, Ni and Cu are preferable, and VO and Cu are particularly preferable.

In squarylium compounds in the formulas (I) to (X), according to the kind of substituent and in the case of a tetraazaporphyrin compound in the formula (XI), according to the combination of a substituent and the central metal M, the absorbing wavelength differs.

As preferable examples of squarylium compound in the formula (V) for providing the minimum value K of transmittance around 530-600 nm, the compounds described in Japan patent publication 2001-265276 can be cited.

Preferable squarylium compounds in the formulas (III) for providing the minimum value K of transmittance near 530-600 nm include compounds in which m=3, n=O or m=3, n=1 and R₁ is an alkyl groups which may have a substituent.

Preferable specific examples thereof are shown below.

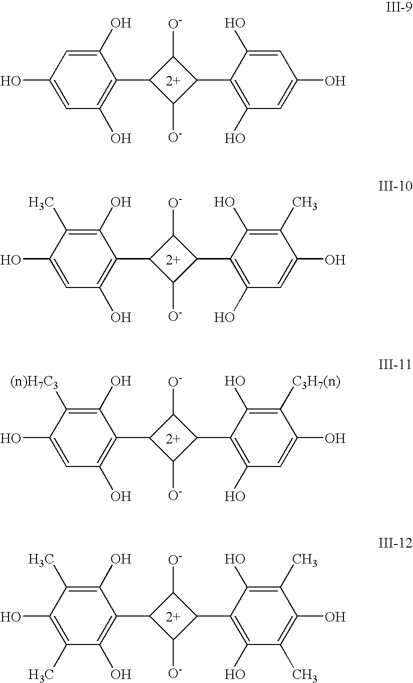

Preferable squarylium compounds in the formulas (VII) for providing the minimum value K of transmittance near 530-600 nm include compounds in which Z is an imino group, L is a hydrogen atom and R₆ and R₇ are alkyl groups which may have a substituent, or aryl groups which may have a substituent.

Preferable specific examples thereof are shown helow.

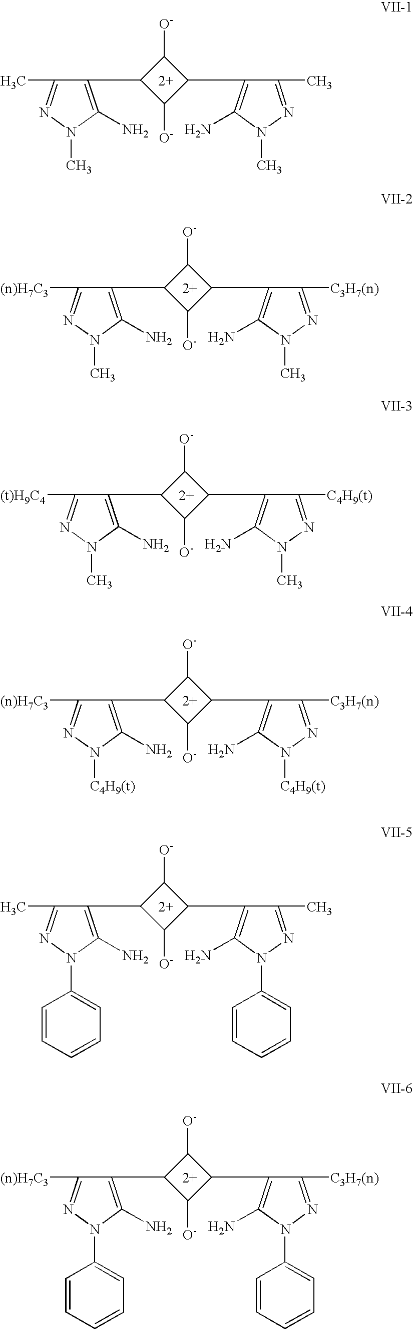

As the squarylium compound in the formula (VIII) for providing the minimum value K of transmittance near 530-600 nm, a compound expressed by formula (VIII) is preferable in which R₁ is an alkyl group, in —W—X—R₂, W is an imino group, X is a carbonyl group or sulfonyl group, R₂ is an alkyl group which may have a substituent, an alkenyl group which may have a substituent, or an aryl group which may have a substituent, 1=2 or 3, m=0 or 1, n=0 or 1, Z is an oxygen atom, L is a hydrogen atom, R₆ and R₇ are alkyl groups which may have a substituent, or aryl groups which may have a substituent, or a compound in which R1 is an alkoxy group, 1=0, m=3, n=0, Z is an imino group, L is a hydrogen atom, and R₆ and R₇ are alkyl groups which may have a substituent, or aryl groups which may have a substituent.

Preferable specific examples thereof are shown below.

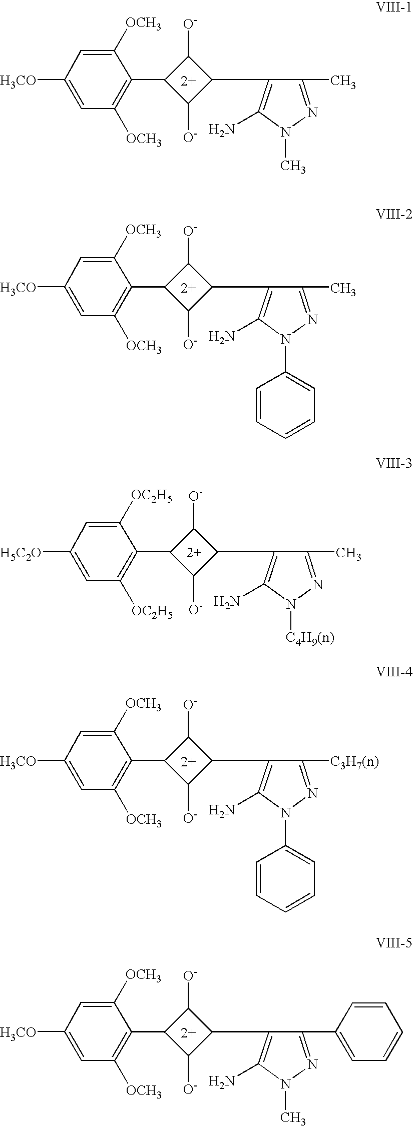

As the squarylium compound in the general formula (1×) for providing the minimum value K of transmittance near 530-600 nm, a compound expressed by formula (IX) is preferable in which R₁ is a hydrogen atom, alkyl group or aryl group, R₁ is an alkyl group, alkoxy group, halogen atom or aryl group, and s is 0-2.

Preferable specific examples thereof are shown below.

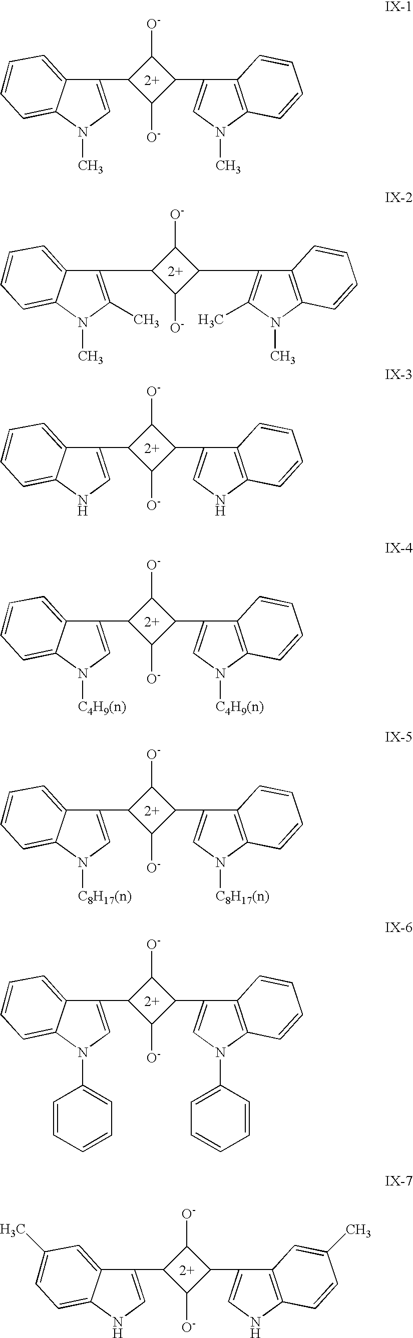

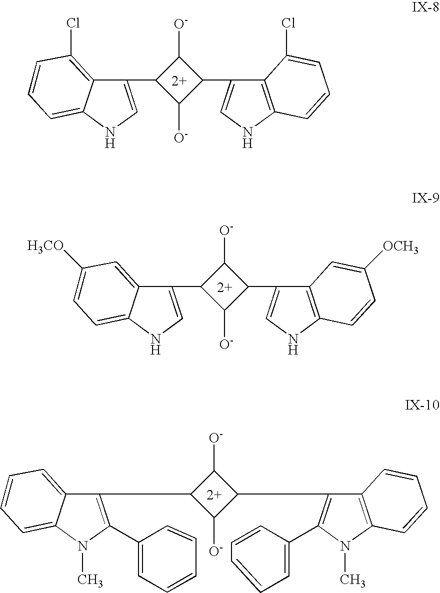

As the squarylium compound in the formula (X) for providing the minimum value K of transmittance near 530-600 nm, a compound expressed by the formula (X) is preferable in which R₁ is a hydrogen atom, alkyl group or aryl group, R₂ is an alkyl group or aryl group, s=2 or 3.

Preferable specific examples thereof are shown below.

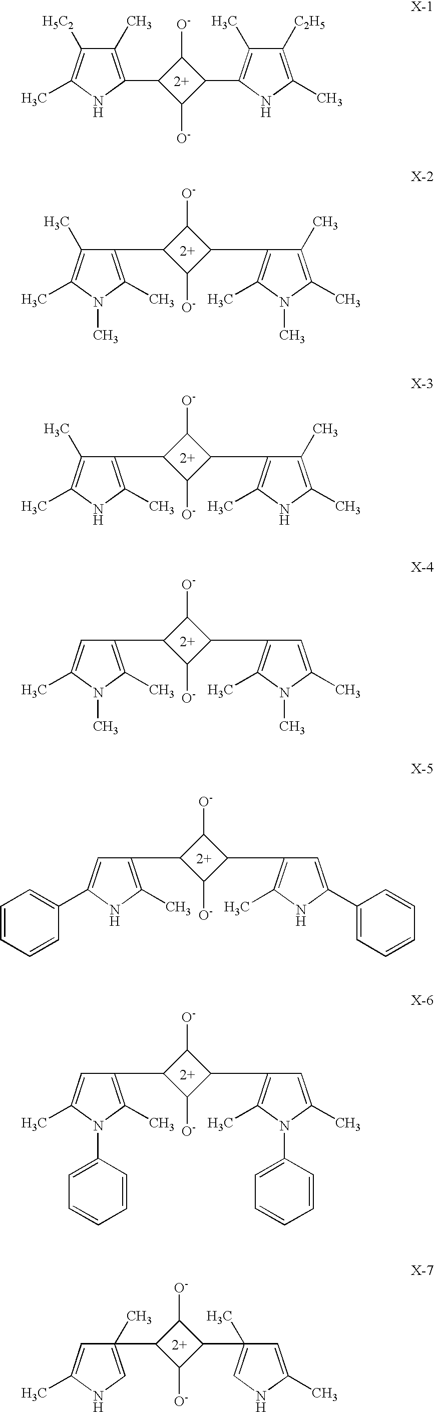

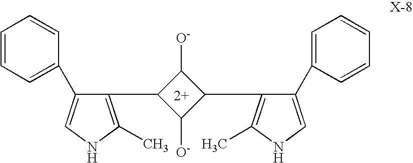

As the tetraazaporphyrin compound for providing the minimum value K of transmittance near 530-600 nm, a compound expressed by the formula (XI) is preferable in which at least four of R₁-R₈ are alkyl groups with the remainder being hydrogen atoms, or a compound in which R₁ and R₂, R₃ and R₄, R₅ and R₆, and R₁ and R₈ are coupled together to form aliphatic carbon rings such as —(CH₂)₃—, —(CH₂), or —(CH₂)₅—, and the metallic atom M is VO, Cu, Ni or Co.

Preferable specific examples thereof are shown below.

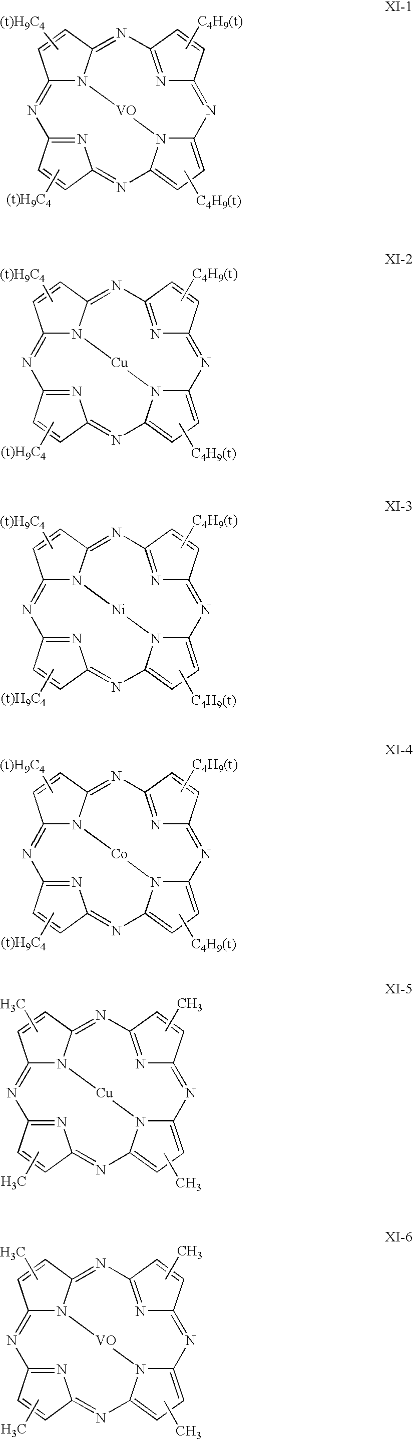

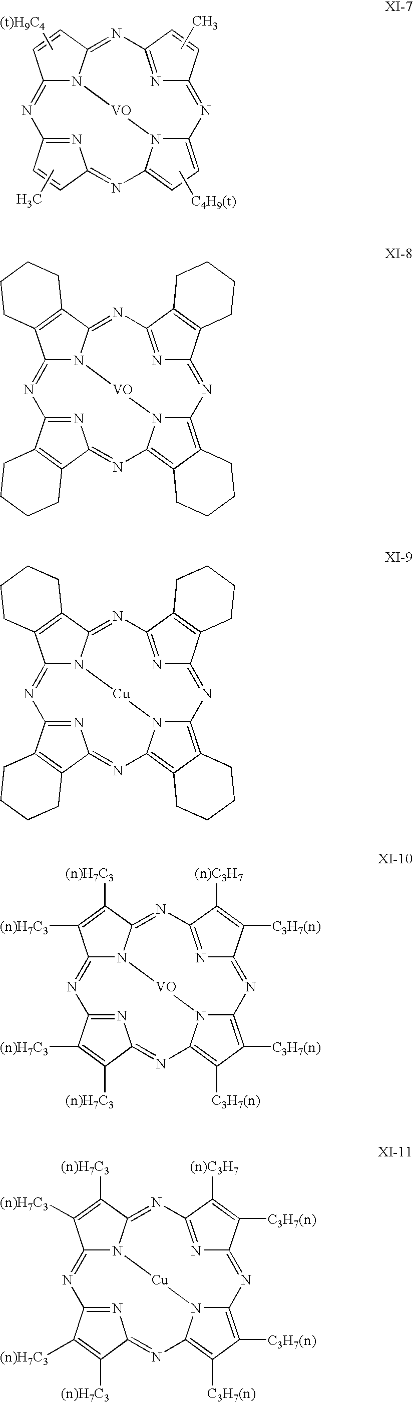

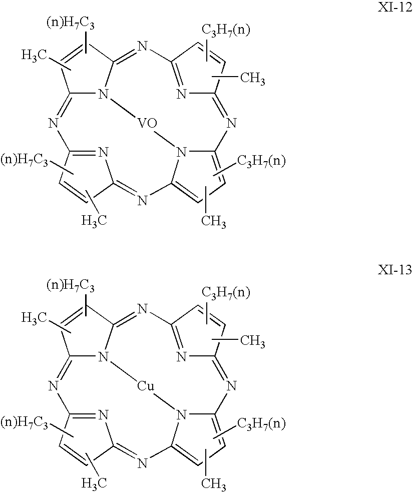

The compounds expressed by the formulas (V)—(XI), (I) and (II), which have the maximum absorption in the wavelength range of 530-610 nm, for use in the filter of the present invention for solving the second problem preferably have a sharp valley shaped transmittance curve so as not to impair emissions of the display, with the half value width of the transmittance curve being 60 nm or under.

### SYNTHESIS EXAMPLE 1

### Synthesis of Formula I-2

Using 3,4-dihydroxy-3-cyclobuten-1,2-dione thionyl chloride as a raw material, 1,2-dichlorocyclobutane-3,4-dione was synthesized by a method described in Tetrahedron Letters, 781(1970).

Next, using 1-2-dichlorocyclobutane-3,4-dione (A), 2-methoxy-1-(4-hydroxyphenyl)cyclobutane 3,4-dione [1H-NMR (400 MHz, in CDCl3 δ, ppm); 3.90 (s, 3H), 7.04 (d, 2H), 8.11 (d, 2H)]] was synthesized through 2-chloro-1-(4-methoxypheny)cyclobutane 3,4-dione [E1-MS; m/z 0.222 (M+), 1H-NMR (400 MHz, in CDCl3 δ, ppm); 3.93 (s, 3H), 7.08 (d, 2H), 8.25 (d, 2H)]] by a method described in Dyes and Pigments 49,161 (2001).

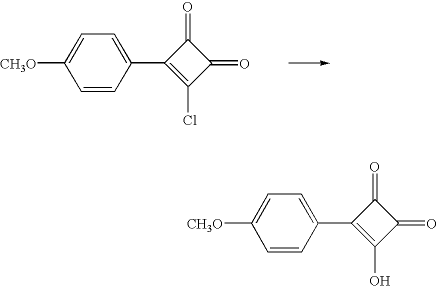

Next, 0.10 g (0.49 mmol) 2-hydroxy-1-(4-methoxyphenyl)cyclobutane 3,4-dione, 0.14 g (0.49 mmol) n-decanoic acid (3,5-dihydroxy-phenyl)-amide, 20 ml toluene, and 20 ml n-butanol are put in a reaction container, added to a reaction container having a Dean Stark apparatus, and is heated under reflex for four hours.

After reaction, the reaction mixture was let to cool, deposit was filtered, and washed with toluene/hexane and dried. 0.15 g (yield 65.8%) of an intended compound (1A-2) was obtained.

[Visible portion absorption λ max: 552 nm (tetrahydrofuran) mass-spectrum MALDI-TOF MS (neg, no matrix) method: m/z=465 (M−)]

### SYNTHESIS EXAMPLE 2

### Synthesis of Formula I-4

0.10 g (0.49 mmol) of 2-hydroxy-1-(4-methoxyphenyl)cyclobutane 3,4-dione, 0.063 g (0.50 mmol) trihydroxybenzene, 20 ml toluene, and. 20 ml n-butanol are put into a reaction container, added to a reaction container having a Dean Stark apparatus, and was heated under reflex. After reaction, the reaction mixture was let to cool, deposit was filtered, and washed with toluene/hexane and dried. 0.12 g (yield 85.0%) of an intended compound (1-4) was obtained.

[Visible portion absorption λ max: 532 nm (tetrahydrofuran), mass-spectrum MALDI-TOF MS (negative ion mode, matrix: a —CHCA) method: m/z=311 (M−H)]

### SYNTHESIS EXAMPLE 3

### Synthesis of Formula III-3

0.30 g of 2′-nonenoic acid (3,5-hydroxyphenylamide) and 0.065 g of 3,4-dihydroxy-3-cyclobutene-1,2 dione were put in a reaction container having a Dean Stark apparatus together with a mixed solvent of 20 ml toluene and 20 ml n-butanol, and the mixture was heated under reflux for four hours for reaction. After the reaction, the reaction mixture was let to cool, deposit was filtered, and washed with toluene and dried. 0.21 g (yield 60.9%) of an intended compound (III-3) was obtained.

[Visible portion absorption λ max: 609 nm (tetrahydrofuran), mass-spectrum DEI MS (pos) method: m/z=605 (M+H)]

### SYNTHESIS EXAMPLE 4

### Synthesis of Formula II-5

0.251 g of 2′-ethylhexanoic acid (3,5-dihydroxyphenylamide), 0.14 g of 1-methyl-3-n-propyl-2-pyrazoline-5-on, and 0.114 g of 3,4-dihydroxy-3-cyclobutene-1,2-dione were put in a reaction container having a Dean Stark apparatus together with a mixed solvent of 20 ml toluene and 20 ml n-butanol, and the mixture was heated under reflux for four hours for reaction. After the reaction, the reaction mixture was let to cool, deposit was filtered, and washed with toluene and dried. 0.25 g of a reaction product was obtained.

By 1H-NMR [500 MHz, d8-THF, 6 (ppm), 25° C.], it was determined to be an 18:29:53 mixture of 1,3-bis(5-hydroxy-1-methyl-3-propyl-1H-pyrazol-4-yl) cyclobutenediylium-2,4-diolate, 1,3-bis(2-(2-ethylhexanoyl)amino-4,6-dihydroxy-phenyl) cyclobutenediylium-2,4-diolate, and the formula (II-5). Also, Mass, NMR and IR of 1,3-bis(5-hydroxy-1-methyl-3-propyl-1H-pyrazol-4-yl)cyclobutenediylium-2,4-diolate, and 1,3-bis(2-(2-ethylhexanoyl)amino-4,6-dihydroxy-phenyl) cyclobutenediylium-2,4-diolate were coincident with those described in Example 4 of JP patent application 2000-149260 and Example 4 of JP patent application 2000-266415, respectively. II-5;

Visible portion absorption; λ max: 549 nm (tetrahydrofuran)

Mass spectrum; DEI-MS (pos) method: m/z=469 (M+H)

IH-NMR [500 MHz, d8-THF, δ (ppm), 25° C.];

10.32 (1H,s), 7.96 (1H,d), 5.94 (1H,d), 3.57 (3H,s), 2.83 (2H,t), 2.52 (1H,m), 1.80, 0.80 (19H,m)

The filter for an electronic display of this invention contains the abovementioned squarylium compound and/or tetraazaporphyrin compound singly or mixed. As the form of containing, typically, they may be contained in a laminate in which a resin containing a squarylium compound and/or tetraazaporphyrin compound is formed on a sheet-like or film-like transparent substrate by a binder resin containing the abovementioned squarylium compound and/or tetraazaporphyrin compound, or a single-layer sheet or film comprising a binder resin itself that contains the abovementioned squarylium compound and/or tetraazaporphyrin compound.

If the filter contains a plurality of such squarylium compounds and/or tetraazaporphyrin compounds, it may be in the form of a laminate in which the individual compounds are in different layers by separately mixing them in separate binder resins and laminating the binder resins, each containing one squarylium compound and/or tetraazaporphyrin compounds.

With the filter for an electronic display of the present invention which solves the second problem, in order to perform necessary functions as the filter, such as reflection prevention, near infrared absorption and electromagnetic wave absorption, for example, the minimum value of transmittance in the 530-600 nm wavelength range is 30% or under, preferably 20% or under. In this case, the values a and b of transmittance (%) at 435 nm and 545 nm are set such that the value c of transmittance (%) at 610 nm and the values a and b of transmittance (%) will be |c-a|≦10 (%), |c-b|≦10 (%), |a-b|≦10 (%), so that the filter for an electronic display will not be colored unnaturally.

But in order not to cause a marked drop in the brightness of emissions of the electronic display, the luminous transmittance Y1 should be 35% or over, preferably 40% or over, more preferably 45% or over. The luminous transmittance is defined under JIS Z8105-1982 as the ratio of light beams φ t that pass an object to light beams φ i incident into the object, i.e. φt/φi. It is the average of transmittance in the wavelength range of 380-780 nm in view of the relative spectrophotometric responsiveness (spectrophotometric visual efficiency) relative to the responsiveness to brightness of human visual senses. Since it substantially correlates to brightness that shows relative brightness of an object, the luminous transmittance is used as an index of brightness or darkness of a filter.

In order to improve the light resistance of the filter for an electronic display of the present invention which solves the second problem, an ultraviolet absorbing layer may be provided.

The filter for an electronic display of the present invention which solves the second problem may further be provided with a near infrared cutting layer and/or an electromagnetic wave cutting layer. The near infrared cutting layer is provided on the front side of the display in order to present malfunction of a remote controller or in transmittance type optical communication, caused by near infrared rays radiated from a plasma display. Electromagnetic wave cutting layer may be provided by deposition or sputtering of a metallic oxide, or a mesh by etching of a copper foil or a copper plating layer. It cuts electromagnetic waves radiated from an electronic display.

The filter for an electronic display of the present invention can be used singly, or may be used in the form of a laminate obtained by laminating it to a transparent glass sheet or a transparent resin board. Also, the present invention may be embodied by combining characteristics of a plurality of members such as members directly bonded to the display surface of an electronic display or members provided as laminates obtained by laminating to a transparent glass or a transparent resin board. In order to obtain an electronic display or a plasma display panel display device using the filter for an electronic display of the present invention, any known display device or commercial device may be used as a display device without limitations.

While further detailed description will be made by examples about the present invention which solve the second problems, this invention is not limited to the following Examples.

Filter Evaluation Method

1. Transmittance:

Using the spectrophotometer UV3100 pc made by SHIMADZU Corporation, the transmittance of the filter was measured at light beam wavelengths of 435 nm, 545 nm and 610 nm.

2. Visual Evaluation of Coloring of the Filter:

After a front glass filter has been removed from the plasma display (W32-PD2100) made by HITACHI, the filter was attached to the front side of the display panel. With the plasma display turned off, the filter was illuminated by one of an ordinary white fluorescent lamp and a three-wavelength band emission type daylight white fluorescent lamp, and the color of the filter was visually evaluated. Evaluation was made in a darkroom in which are provided an ordinary white fluorescent lamp and a three-wavelength band emission type daylight white fluorescent lamp on its ceiling.

### EXAMPLE 3

0.150 wt %/resin content of the compound of the Example (III-3; squarylium compound), 0.320 wt %/resin content of the compound of the Example (III-11; squarylium compound), and the compound of the Example (IV-3: dipyrazolilmetin compound), THF, DME and toluene were mixed and dissolved in a 30 wt % toluene solution of a polymethyl methacrylate. The solution was applied to a polyethylene terephthalate film (PET film made by Mitsubishi Chemical Polyester Film “T 600E”, thickness 50 micrometers) with a No. 30 bar coater (made by TAIYU KIZAI), and dried. A filter having a coating film having a film thickness of 4.5 micrometers was obtained. This is the filter A.

7.6 wt %/resin content of a diimonium near infrared absorbing pigment (tetrafluoroantimonate of N,N,N′N′-tetrakis(p-dibutylaminophenyl)-p-phenylene diimonium), toluene, MEK were mixed and dissolved in a 30 wt % tluene solution of a polymethyl methacrylate resin (DIANAL BR-80 made by Mitsubishi Rayon). The solution was applied to polyethylene terephthalate film (PET film “T 600E” made by Mitsubishi Chemical Polyester Film Co., thickness: 50 micrometers), and dried to obtain a film having a coating film. 9.2 wt %/resin content of dithiol nickel complex near infrared absorbing pigment {bis-2,2-[1,2-di(3-chlorophenyl)ethylenediimine]benzenethiolate} nickel (II), toluene and THF were mixed and dissolved in a 30 wt % toluene solution of polymethylmethacrylate resin (DIANAL BR-80 made by Mitsubishi Rayon), and applied to the back of the above film to obtain a filter. The filter thus obtained, the above filter A, an electromagnetic wave shield mesh (wire width 10 micrometers, wire pitch 250 micrometers), and glass were laminated one on another, and further a reflection preventive film (REALOOK 8500 made by NOF Corporation) was laminated by an adhesive to which was added a UV absorber to obtain a filter for a plasma display panel.

The filter thus obtained was evaluated for transmittances at 610 nm, 545 nm and 435 nm and its color tones under an ordinary white fluorescent lamp and a three band emission type daylight white fluorescent lamp. The evaluation results are shown in Table 2.

### EXAMPLE 4

A filter for a plasma display panel was obtained in the same manner as in Example 1 except that the amount of the Example (III-3; squarylium compound) was changed to 0.210 wt %/resin content, instead of the compound of the Example (III-10; squarylium compound), 0.150 wt %/resin content of the compound of the Example (III-10; squarylium compound) was used, and the amount of the compound of the Example (IV-3; dipyrazolilmetin compound) was changed to 0.600 wt %/resin content.

The filter thus obtained was evaluated for transmittances at 610 nm, 545 nm and 435 nm and its color tones under an ordinary white fluorescent lamp and a three band emission type daylight white fluorescent lamp. The evaluation results are shown in Table 2.

### EXAMPLE 5

A filter for a plasma display panel was obtained in the same manner as in Example 3, except that the amount of the Example (III-3; squarylium compound) was changed to 0.120 wt %/resin content, instead of the compound of the Example (III-11; squarylium compound), 0.192 wt %/resin content of the compound of the Example (IV-1; tetraazaporphyrin compound) was used, and instead of the compound of the Example (XI-3; dipyrazolylmetin compound), 0.048 wt %/resin content of the compound of the Example (III-9; squarylium compound) was used.

The filter thus obtained was evaluated for transmittances at 610 nm, 545 nm and 435 nm and its color tones under an ordinary white fluorescent lamp and a three band emission type daylight white fluorescent lamp. The evaluation results are shown in Table 2.

### COMPARATIVE EXAMPLE 3

A filter for a plasma display panel was obtained in the same manner as in Example 3, except that instead of the compound of the Example (III-3; squarylium compound), (0.384 wt %/resin content of the compound of the Example (XI-1; tetraazaporphyrin compound) was used, instead of the Example (III-11), 0.064 wt %/resin content of the compound of the Example (III-9; squarylium compound) was used, and the amount of the compound of the Example (IV-3; dipyrazolilmetin compound) was changed to 0.350 wt %/resin content.

The filter thus obtained was evaluated for transmittances at 610 nm, 545 nm and 435 nm and its color tones under an ordinary white fluorescent lamp and a three band emission type daylight white fluorescent lamp. The evaluation results are shown in Table 2.

### COMPARATIVE EXAMPLE 4

A filter for a plasma display panel was obtained in the same manner as in Example 3, except that the amount of the compound of the Example (III-3; squarylium compound) was changed to 0.240 wt %/resin content, instead of the compound of the Example (III-3; squarylium compound), 0.159 wt %/resin content of the compound of the Example (III-9; squarylium compound) was used, and the compound of the Example (IV-3; dipyrazolylmetin compound) was not added.

The filter thus obtained was evaluated for the transmittances at 610 nm, 545 nm and 435 nm and its color tones under an ordinary white fluorescent lamp and a three band emission type daylight white fluorescent lamp. The evaluation results are shown in Table 2.

Visual Evaluation of Coloring of the Filter

The filters of Examples 3-5 were naturally colored near gray when illuminated by either of an ordinary fluorescent lamp and a three band emission fluorescent lamp. Comparative Example 3 was colored gray when illuminated by an ordinary fluorescent lamp, but colored unnatural red under a three band emission fluorescent lamp. Comparative Example 4 was colored unnatural purple under either of an ordinary fluorescent lamp and a three band emission fluorescent lamp.

TABLE 2

| | | | | Filter color | |
|---|---|---|---|---|---|
| | | | | Ordinary | 3-wavelength |
| | Transmittance (%) | | | fluorescent | band type |
| | 610 nm | 545 nm | 435 nm | lamp | fluorescent lamp |
| Ex. 3 | 41.8 | 43.7 | 49.6 | gray | bluish gray |
| Ex. 4 | 44.0 | 43.3 | 42.5 | gray | gray |
| Ex. 5 | 49.9 | 51.3 | 55.1 | greenish gray | gray |
| Comp. | 59.5 | 47.7 | 47.1 | gray | red |
| Ex. 3 | | | | | |
| Comp. | 41.1 | 42.7 | 55.0 | reddish purple | purple |
| Ex. 4 | | | | | |

Next, the present invention that solves the third problem will be described in detail.

(1) Transparent Resin Substrate

A transparent resin which is a material for the transparent resin substrate forming the transparent laminate of the present invention that solves the third problem is not specifically limited so long as it is substantially transparent and low in light absorption and scattering. Specific examples thereof include polyester resins, polycarbonate resins, poly(metha)acrylate resins, cyclic olefin resins, polystyrene, polyvinyl chloride and polyvinyl acetate.

(a) Polyester Resins

Polyester resins are manufactured by condensation polymerization of dicarboxylic acid with glycol.

Dicarboxylic acids include terephthalic acid, adipic acid and maleic acid. Glycols include ethylene glycol, propylene glycol and 1,4-butane diol.

Preferable polyester resins include polyethylene terephthalate (PET) and polyethylene butyrene terephthalate (PBT).

For strength and transparency, it is extremely preferable to use a polyester resin as the transparent resin substrate. But if necessary, other resins may be used.

(b) Polycarbonate Resins

Polycarbonate resins are manufactured by reacting dihydric phenols with carbonate precursors by a solution method or a melting method.

Dihydric phenols include 2,2-bis(4-hydroxyphenyl) propane[bisphenol A], 1,1-bis(4-hydroxyphenyl)ethane, 1,1-bis(4-hydroxyphenyl)cyclohexane, 2,2-bis(4-hydroxy-3,5-dimethylphenyl)propane, 2,2-bis(4-hydroxy-3,5-dibromophenyl)propane, 2,2-bis(4-hydroxy-3-methylphenyl) propane, bis(4-hydroxyphenyl)sulfide, and bis(4-hydroxyphenyl)sulfone.

Preferable dihydric phenols are bis(4-hydroxyphenyl)alkanes, particularly ones of which the major component is bisphenol.

Carbonate precursors include phosgene and diphenyl carbonates.

(c) Poly(metha)acrylate Resins

Poly(metha)acrylate resins include polyacrylate resins and polymethacrylate resins.

Typical polymethacrylates include monopolymers of methyl methacrylate, or a copolymer of a polymeric unsaturated monomer mixture containing methyl methacrylate by 50% or over.

Polymeric unsaturated monomers that can be copolymerized with methyl methacrylate include methyl acrylate, ethyl (metha)acrylate (ethyl acrylate or ethyl methacrylate, ditto below), butyl (metha)acrylate, cyclohexyl (metha)acrylate, (metha)acrylate-2-ethylhexyl, methoxy (metha)acrylate, ethoxyethyl (metha)acrylate, (metha)acrylate-2-hydroxyethyl, (metha)acrylate-N,N-diethylaminoethyl, glycidyl (metha)acrylate, tribromophenyl (metha)acrylate, tetrahydrofurfuryl (metha) acrylate, ethylene glycol di(metha)acrylate, triethylene glycol di(metha)acrylate, tripropylene glycol di(metha) acrylate, trimethylol ethane di(metha)acrylate, neopentyl glycol di(metha)acrylate, trimethylol propane tri(metha) acrylate, and pentaerythritol tetra(metha)acrylate.

(d) Cyclic Olefin Resins

Cyclic olefin resins include monopolymers by vinylene polymerization of cyclic olefins selected from monocyclic olefins such as cyclobutenes, cyclopentenes and cyclohexens and polycyclic olefins such as norbornenes and tricyclo-3-decenes, copolymers by vinylene polymerizations of a plurality of cyclic olefins, and copolymers of such cyclic olefins and ethylene.

Such cyclic olefins include monocyclic olefins such as cyclopentenes including cyclobutene, cyclopentene and 4-methylcyclopentene, and cyclohexens including cyclohexene, 3-methyl cyclohexene and 3-vinylcyclohexene; and polycyclic olefins such as norbornenes including norbornene, 1-methylnorbornene, 5-ethylidene-2-norbornene, methylene norbornene, 5-vinyl-2-norbornene and 5-methylene-2-norbornene; tricyclo-3-decenes including tricyclo[4.3.0.12,5]-3-decene and 2-methyltricyclo[4.3.0.1 2,5]-3-decene; dicyclopentadienes including dicyclopentadiene(tricyclo[4.3.0.12,5]-3,7-decadiene, tricyclo[4.3.0.12,5]-3,8-decadiene, and 7-methyldicyclopentadiene; tetracyclo-3-dodecenes including tetracyclo[4.4.0.12,5.17,10]-3-dodecene, 8-methyltetracyclo[4.4.0.12.5.17.10]-3-dodecene and 5,10-dimethyltetracyclo[4.4.0.12,5.17,10]-3-dodecene; pentacyclopentadecenes including pentacyclo[6.5.1.13,6.02, 7.09,13]-4-pentadecene, 10-methylpentacyclo[6.5.1.13,6.02, 7.09,13]-4-pentadecene, and pentacyclo[4.7.0.12,5.08, 13.19, 12]-3-pentadecene; pentacyclopentadecadienes including pentacyclo[6.5.1.13,6.02,7.09,13]-4,10-pentadecadiene, and pentacyclo[6.5.1.13,6.02,7.09,13]-4,11-pentadecadiene, and hexacycloheptadecenes including hexacyclo[6.6.1.13,6.110,13.02,7.09,14]-4-heptadecene.

The kind of the transparent resin may be selected according to the intended use. The transparent resin is formed into a film or sheet (or board) by injection molding, T-die molding, calender molding, compression molding or casting after dissolving in an organic solvent, and is used as the transparent resin substrate in the present invention.

For use as the substrate for a filter, and for performing glass scattering preventive effects, it is used after molded into a sheet (film) having a specific strength.

As for preferable strength, the sheet should have a tear strength of 1.5 N/m under JIS P 8116, and the ratio of longitudinal tear strength/lateral tear strength should be 0.5-2.0. If it has such strengths and strength balance, glass scattering preventive effects improve.

In the present invention that solves the third problem, at least two transparent resin substrates are laminated one on the other. Preferably, at least one of these two layers should have the above-specified strengths and strength balance. Of course, more preferably, both of them have such strengths and strength balance.

For improving glass scattering preventive effects, the sheet (film) has preferably an elongation under ASTM D 882 of 50% or over. This is because the sheet will be stretched without breaking even if the PDP glass should break under external force.

The longitudinal direction of the sheet (film) is the direction in which the sheet or film is mechanically taken up if it is taken up in T-die molding or calendering process. Of course, the lateral direction is the direction perpendicular thereto. If the sheet (film) is formed by e.g. injection molding or casting and has no isotropy, the longitudinal direction may be any direction and the lateral direction is a direction perpendicular to the longitudinal. If the sheet (film) is stretched, the stretching direction is the longitudinal or lateral direction.

In order to obtain a sheet having strength as specified above, though depending upon the kind of resin used, the raw material resin is melted by heating and kneaded, formed into a sheet by e.g. extrusion molding, and stretched.

Stretching treatment is preferably by biaxial stretching because monoaxial (usually longitudinal) stretching impairs strength balance.

The transparent resin may contain known additives such as phenolic or phosphoric antioxidants, halogenic or phosphate flame retardants, heat-resistant anti-aging agents, UV absorbers, lubricants and anti-static agents.

The surface of the transparent resin substrate may be subjected to known surface treatment such as corona treatment, plasma treatment, flame treatment, chemical treatment or application of a primer layer.

Each transparent resin substrate layer is 40-3000 micrometers thick, preferably 40-300 micrometers thick, more preferably 50-180 micrometers thick.

In the present invention that solves the third problem, at least two of the transparent resin substrates are laminated one on the other through an adhesive layer.

By laminating the transparent resin substrates through an adhesive layer, scattering preventive effects of the plasma display if destructed improve greatly.

For a filter for a plasma display panel, performance peculiar to a plasma display is required.

That is, cutting electromagnetic waves and near infrared rays radiated from the plasma display panel is required, or adjusting the neon color inherent to the plasma display panel to a normal color tone is required.

(2) Near Infrared Absorbing (Cutting) Layer

In order to impart the near infrared absorbing effects to the filter of the present invention, for example, a near infrared absorber may be added to the transparent resin (directly added to the transparent resin substrate or formed as a separate layer), or a coating liquid prepared by dispersing or dissolving the near infrared absorber in an organic solvent and adding a binder resin, or a coating liquid comprising a hard coating agent, anchor coating agent or an adhesive to which is added a near infrared absorber may be applied directly or through another layer to the transparent resin substrate.

The near infrared absorbing layer has a near infrared transmittance in the 800-1100 nm wavelength range of 15% or less, preferably 10% or less.

Preferable near infrared absorbers include imonium compounds, diimonium compounds, and aluminum salt compounds.

Imonium compounds and diimonium compounds may be e.g. compounds expressed by the formulas (1)-(4).

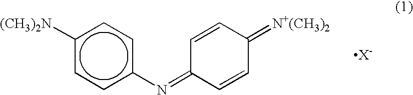

(In the formula, X⁻indicates an anion.)

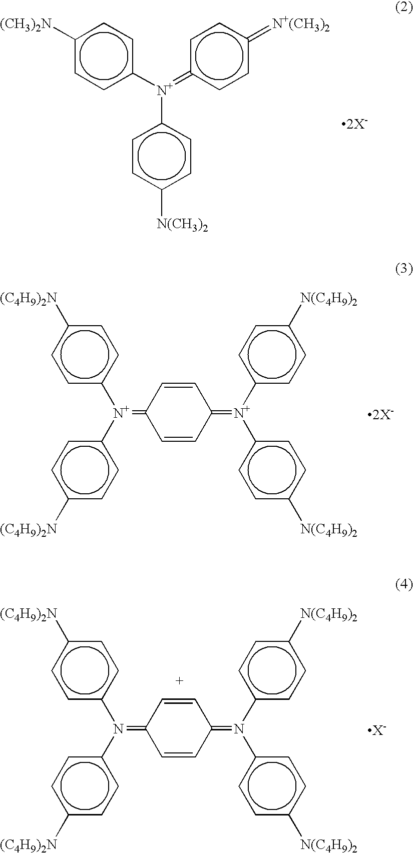

Aluminum salt compounds include a compound expressed by the formula (5). Specific examples of X in the formula include tetrafluoroantimonate ions, perchloric acid ions, fluoroboric acid ions, tetrafluoroarsenic acid ions, periodic acid ions, trifluoroacetate ions and chlorine ions.

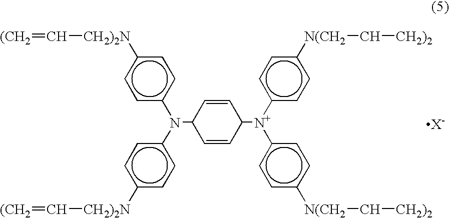

(In the formula, X⁻ indicates an anion.)

Preferable near infrared absorbers are imonium compounds, diimonium compounds, and aluminum salt compounds. But instead of or in combination with these near infrared absorbers, other near infrared absorbers may be used. Such other near infrared absorbers include nitroso compounds and their metal complex salts, cyanine compounds, squarylium compounds, thiolnickel complex salt compounds, aminothiolnickel complex salt compounds, phthalocyanine compounds, naphthalocyanine compounds, triarylmethane compounds, naphthoquinone compounds, anthraquinone compounds and amino compounds, which are all organic substances, and carbon black, antimony oxide, tin oxide doped with indium oxide, and oxides, carbides and borates of metals that belong to the groups 4, 5 and 6 of the periodic table, which are all inorganic substances.

In this case, compounds can be selected from among the above compounds and combined so that the near infrared transmittance in the 800-1100 nm wavelength range will be 15% or under. In particular, in view of transparency and near infrared absorbing performance, the combination of a diimonium compound and an aminothiolnickel complex salt compound is preferable.

Aminothiolnickel complex salt compounds may be a compound having a structure expressed by the formula (7).

R1-R8 in the formula are atoms identical to or different from one another, or functional groups that are identical to or different from one another. Specifically, they are at least one kind selected from hydrogen atoms, alkyl groups, aryl groups, alalkyl groups, alkoxy groups, nitro groups, halogen atoms, amino groups, substituted amino groups and cyano groups. Preferably they are hydrogen atoms or amino groups.

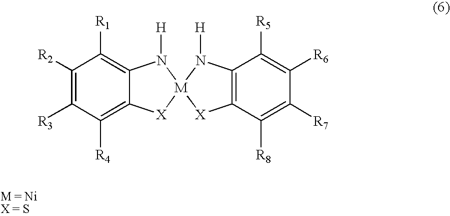

The transparent resin used to form a near infrared cutting layer by adding a near infrared absorber to the transparent resin is not specifically limited so long as it is substantially transparent and not high in absorption and scattering. Specifically, it may be one of the above-described polycarbonate resins, poly(meta)acrylate resins, cyclc olefin resins, polyester resins, polystyrene, polyvinyl chloride and polyvinyl acetate.

Such a transparent resin may contain known additives such as phenolic or phosphoric antioxidants, halogen agents, phosphoric and other flame retardants, heat-resistant anti-aging agents, UV absorbers, lubricants, antistatic agents, etc.

A layer having near infrared cutting effects may be formed by adding one of the abovementioned near infrared absorbing agents to the transparent resin and forming the mixture into a film or sheet using the method as described above such as injection molding, T-die molding, calender molding or compression molding, or by dissolving it in an organic solvent and casting.

The addition amount of the near infrared absorbing agent should be 0.005-20 parts by weight, preferably 0.01-15 parts by weight with respect to 100 parts by weight of the resin.

If the addition amount of the near infrared absorbing agent is too small, while the transmittance of visible light beams will improve, the near infrared absorbing ability will lower.

On the other hand, if it is too large, while the near infrared absorbing ability improves, the visible light beam transmittance lowers.

The near infrared cutting layer may be formed by applying a coating liquid prepared by dissolving or dispersing a near infrared absorber in an organic solvent and adding a binder resin, or a coating liquid prepared by adding a near infrared absorber to a hard-coating agent, anchor-coating agent or adhesive to one of the transparent resin substrate, electromagnetic wave shield layer and scratch-preventive layer according to the laminating order.

The organic solvent may be a halogen, alcohol, ketone, ester, aliphatic hydrocarbon, aromatic hydrocarbon or ether solvent, or a mixture thereof.

The binder may be an ester resin, acryl resin, melamine resin, urethane, polycarbonate resin, polyolefin resin or polyvinyl resin.

The hard-coating agent may be one containing as its major component an acrylate or multifunctional acrylate such as polyurethane acrylate or epoxy acrylate, a photopolymerization initiator, or an organic solvent.

The near infrared absorber is added by normally 1-40 parts by weight, preferably 2-15 parts by weight with respect to 100 parts by weight of the hard-coating agent, and the mixture is applied by dipping, flow coating, spraying, bar coating, gravure coating, roll coating, blade coating, or air knife coating. Thereafter, the solvent is dried, and active energy beams are irradiated by use of a xenon lamp, low-pressure mercury lamp or high-pressure mercury lamp to cure the coating liquid to form a near infrared cutting layer. The thickness of the near infrared cutting layer is normally 0.5-50 micrometers, preferably 1-20 micrometers.

The anchor coating agent may be an isocyanate, polyurethane, polyester, polyethyleneimine, polybutadiene, alkyltitanate or any other known anchor coating agent.

Preferably, it is an isocyanate compound, polyurethane, urethane prepolymer, a mixture thereof or a reaction product thereof, or a mixture of a polyester polyol or polyether polyol and an isocyanate.

The near infrared absorber is added normally by 1-50 parts by weight with respect to 100 parts by weight of the anchor coating agent, and the mixture is applied by dipping, flow coating, spraying, bar coating, gravure coating, roll coating, blade coating, or air knife coating. Thereafter, the solvent is dried to form a near infrared cutting layer.

The amount of the coating liquid applied is normally 0.01-8 g/m² (dried solid content), preferably 0.1-5 μg/m² (dried solid content).

The adhesive may be a rubber such as styrene butadiene rubber, polyisobutyrene, natural rubber, neoprene or butyl rubber, a low-polymerization polymer, such as polyacrylate alkyl ester, or one to which is further added an adhesive such as PICCOLYTE (trademark), POLYPALE (trademark) or rosin ester.

The near infrared absorber is added normally by 0.05-5 parts by weight with respect to 100 parts by weight of the adhesive, and the mixture is dispersed or dissolved in one or a mixture of organic solvents such as halogen, alcohol, ketone, ester, ether, aliphatic hydrocarbon and aromatic hydrocarbon solvents to adjust the viscosity. The liquid obtained is applied by dipping, flow coating, spraying, bar coating, gravure coating, roll coating, blade coating, or air knife coating. Thereafter, the solvent is dried to form a near infrared cutting layer. The thickness of the near infrared cutting layer is normally 5-100 micrometers, preferably 10-50 micrometers.

(2) Electromagnetic Wave Shield Layer

In order to impart electromagnetic wave shielding effect to the filter for a plasma display of the present invention, a transparent conductive film made of a metal or metallic oxide so as to transmit visible light or a mesh layer made of a conductive material may be provided e.g. on a transparent resin substrate.

The transparent conductive film is formed of a metal or metallic oxide forming an electromagnetic wave shield layer, preferably silver, tin oxide, indium oxide-doped tin oxide (ITO) or antimony-doped tin oxide (ATO) formed directly or indirectly on a transparent resin substrate by vacuum deposition, ion plating, sputtering, CVD, plasma chemical deposition, etc.

It may also be formed by coating on a transparent substrate with a metallic paste (metallic particles dispersed in transparent binder).

If the transparent conductive film is used, the thickness of the electromagnetic wave shield layer is, though dependent on the properties required and the intended use, preferably 8-300 nm for transparency.

The mesh made of a conductive material may be made by coating a mesh formed by weaving fiber such as polyester with a conductive material of a metal such as copper, black metal or carbon black.

The mesh may be made by laminating a metallic foil, preferably copper foil on a film of e.g. polyester with an adhesive, and patterning into a mesh by photoetching comprising e.g. photoresist application, exposure, development, and wet etching.

The pattern width (or thickness) of the wire forming the mesh) is 2-40 micrometers, preferably 2-20 micrometers.

To ensure the light beam transmittance, the rate of opening of the mesh made of a conductive material is preferably 50% or over.

(3) Adhesive Layer

An adhesive layer its provided on the filter for a plasma display of the present invention that solves the third problem.

Through the adhesive layer, during manufacturing steps of a plasma display, or after its manufacture, the filter is bonded to the front side of the plasma display.

By doing so, it is not necessary to provide a near infrared absorbing layer, electromagnetic shield layer and any other layer on the front side of the plasma display itself one on another. Also, since the filter is integrally formed with the plasma display, it becomes possible to reduce the thickness of the plasma display.

The adhesive forming the adhesive layer may be rubbers such as styrene-butadiene rubber, polyisobutyrene, natural rubber, neoprene or butyl rubber, or a low-polymerization polymer such as a polyalkyl acrylate ester such as polymethyl acrylate, polyethyl acrylate or polybutyl acrylate, with or without PICCOLYTE (trademark), POLYPALE (trademark) or rosin ester added thereto.

When bonding the filter to a plasma display, if foams are present between the surface of the plasma display and the filter, there will be big practical problems that images are distorted or cannot be seen clearly. Thus care must be taken so that foams will not be trapped.

Since the surface of the plasma display itself heats up, an adhesive that tends to produce gas when heated should be avoided.

If the production of gas is possible, addition of e.g. an absorbing agent should be considered.

For these reasons, the use of such an adhesive is preferable. When a 30-micrometer thick polyester film is stuck on a 3 mm-thick glass sheet with a 30-micrometer-thick adhesive, the adhesive shows the 180-degree peeling strength after holding for 10 days at 80° C. of 300 g/cm, preferably 400 g/cm.

Specifically, a polymer adhesive such as polyalkyl acrylate ester or a rubber adhesive such as styrene butadiene rubber is dispersed or dissolved in an organic solvent or a mixture of solvents such as halogen, alcohol, ketone, ester, ether, aliphatic hydrocarbon or aromatic hydrocarbon solvents to adjust the viscosity, and the mixture is applied by a method such as dipping, flow coating, spraying, bar coating, gravure coating, roll coating, blade coating and air knife coating, and then the solvent is dried to form an adhesive layer. The thickness of the adhesive layer is normally 5 to 3000 μm preferably 10 to 100 μm.

The filter according to the present invention that solves the third problem has two or more layers of transparent resin substrates and two or more adhesive layers laminated together. That is, two transparent resin substrates are laminated together with an adhesive, and an adhesive layer for laminating with a plasma display is provided on one side thereof.

By laminating two transparent resin substrates with an adhesive, even if the plasma display is broken, the two adhesive layers and two layers of transparent resin substrate prevent transfer of destruction, so that safety improves markedly.

By laminating two thin transparent resin substrates, destruction transfer-preventive effects are better than with a single thick transparent resin substrate. That is, even if the plasma display is boken and the transparent resin substrate close to the display is cut by broken pieces, the adhesive layer and the other transparent resin substrate will serve as a shock absorber, thereby preventing transfer of destruction. Further, it is possible to reduce the total thickness of the filter compared to a filter having a single thick transparent resin substrate.

A release film may be provided on the adhesive layer to protect the adhesive layer until it is stuck on the surface of a plasma display to prevent dust from sticking to the adhesive layer.

Between the adhesive layer and the release film at the edge of the filter, a portion where the adhesive layer is missing may be provided, or a non-adhesive film may be disposed to provide a non-adhesive portion as a peeling start portion so that laminating work can be done easily.

The filter for a plasma display of the present invention which solves the third problem may be provided, besides the near infrared absorbing layer, the electromagnetic wave shielding layer and the adhesive layer, with a visible light beam control layer, reflection-preventive layer, anti-glare layer, damage-preventive layer, anti-static layer, anti-soil layer, etc.

While it is possible to provide various layers, it is preferable that as the filter for a plasma display, the visible light beam transmittance in the 400-700 nm wavelength range is preferably 35% or over.

The order of lamination is not specifically limited. But the reflection-preventive layer is preferably provided on the outermost side (viewer's side). A damage-preventive layer is effective in increasing the durability.

(4) Visible Light Beam Control Layer

The visible light beam control layer is a resin layer containing a neon emission cutting (absorbing) pigment and a color adjusting pigment.

A plasma display has orange emissions resulting from neon in the 580-600 nm range. By cutting light in this range, brilliant red is obtainable. The neon emission cutting pigment is a pigment that cuts neon emissions in the 580-600 nm range, and a known pigment having maximum absorption at 580-600 nm may be used. In order to effectively cut neon emissions, one that steeply cut light in 580-600 nm range is preferable. Examples of such pigments include squarylium pigments and tetraazaporphyrin pigments.

The color adjusting pigment serves to adjust the color of a filter that has turned blue to bluish purple by the addition of a neon emission cutting pigment, to a natural color (gray), and its absorbing wavelength is not limited.

The visible light beam control layer can be formed by applying directly or through another layer to the transparent resin substrate a coating liquid in which the above pigments are added to a transparent resin (directly mixed into the transparent resin substrate or formed as another layer), or a coating liquid in which it is added to a hard-coating agent, anchor-coating agent, adhesive, C etc.

(5) Damage Preventive Layer

The damage preventive layer is formed by a coating agent containing as the major components an acrylate such as polyurethane acrylate or epoxy acrylate or a multifunctional acrylate, a photopolymerization initiator and an organic solvent. The epoxy acrylate is prepared by esterifying the epoxy group of epoxy resin with acrylic acid and has as the functional group an acryloil group. It may be an acrylic acid addict to a bisphenol A type epoxy resin, or an acrylic acid adduct to a novolak type epoxy resin.

The urethane acrylate is prepared by acryl-modifying an urethane prepolymer obtained by reacting a polyol with a diisocyanate, with an acrylate having a hydroxy group. The polyol may be ethylene glycol, propylene glycol, diethylene glycol, butylene glycol, 1,6-hexanediol, neopentyl glycol, hexanetriol, trimethylol propane, polytetramethylene glycol or a condensation polymer of adipic acid and ethylene glycol. The diisocyanate may be tolylene diisocyanate, isophorone diisocyanate or hexamethylene diisocyanate.

The acrylate having a hydroxy group may be 2-hydroxyethyl acrylate, 2-hydroxypropyl acrylate, pentaerythritol triacrylate, or dipentaerythritol acrylate.

The multifunctional acrylate has three or more acryloil groups in the molecule. Specifically, it may be trimethylolpropane triacrylate, EO-modified trimethylolpropane triacrylate, PO-modified trimethylolpropane triacrylate, tris(acryloxyethyl) isocyanurate, caprolactone-modified tris(acryloxyethyl) isocyanurate, pentaerythritol triacrylate, pentaerythritol tetraacrylate, dipentaerythritol tetraacrylate, dipentaerythritol pentaacrylate, dipentaerythritol hexaacrylate, alkyl-modified dipentaerythritol triacrylate, alkyl-modified dipentaerythritol tetraacrylate, alkyl-modified dipentaerythritol pentaacrylate, caprolactone-modified dipentaerythritol hexaacrylate, or a mixture of two or more of them.

The photopolymerization initiator may be benzoin methylether, benzoin ethylether, benzoin isopropylether, benzoin butylether, diethoxyacetohenone, benzyldimethylketal, 2-hydroxy-2-methylpropiophenone, 1-hydroxycyclohexylphenylketone, benzophenone, 2,4,6-trimethylbenzoindiphenylphosphone oxide, Michler's ketone, N,N-dimethylamino isoamyl benzoate, 2-chlorothioxanthone, or 2,4-diethylthioxanthone. Two or more of them may be used together as the photopolymerization initiator.

The organic solvent may be an aromatic hydrocarbon such as toluene or xylene, an ester such as ethyl acetate, propyl acetate or butyl acetate, an alcohol such as methyl alcohol, ethyl alcohol, n-propyl alcohol, i-propyl alcohol or n-butyl alcohol, a ketone such as acetone, methylethylketone, methylisobutylketone or cyclohexanone, an ether such as 2-methoxyethanol, 2-ethoxyethanol, 2-butoxyethanol, ethylene glycol dimethylether, ethylene glycol diethylether or diethylene glycol dimethylether, or an ether ester such as 2-methoxyethyl acetate, 2-ethoxyethyl acetate or 2-butoxyethyl acetate. Two or more of them may be used together.

Besides these components, in order to improve the wear resistance, a colloidal metal oxide, or a silica zol using an organic solvent as a carrier medium may be added. The damage-preventive layer is formed by applying a coating liquid of the coating agent by dipping, flow coating, spraying, bar coating, gravure coating, roll coating, blade coating, or air knife coating, drying the solvent, and radiating activated energy beams to crosslink and cure the applied coating agent. The activated energy beams may be ultraviolet rays emitted from a light source such as a xenon lamp, low-pressure mercury lamp, high-pressure mercury lamp, ultrahigh-pressure mercury lamp, metal halide lamp, carbon arc lamp or tungsten lamp, or electron beams, α beams, β beams or γ beams emitted from an electron beam accelerator of 20 to 2000 keV. The damage-preventive layer thus formed usually has a thickness of 1-50 micrometers, preferably 3-20 micrometers.

(6) Reflection-Preventive Layer

If a reflection preventive layer is provided, it is formed of silicon oxide, zirconium oxide, titanium oxide, fluorinated magnesium, fluorinated calcium, aluminum oxide or the like which are relatively low in refraction, or a reflection-preventive coating agent (e.g. CYTOP made by ASAHI Glass). One or a plurality of layers of such agents may be provided to form the reflection-preventive layer. The reflection-preventive layer may be formed by applying metallic alkoxide and baking, by vacuum deposition, sputtering, ion-plating, chemical deposition (CVD), plasma chemical deposition, roll coating or dipping. The reflection-opreventive layer is preferably formed on the outermost surface of the transparent laminate. The reflection-preventive layer has normally a thickness of 50-100 nm. A commercial film in which such a reflection-preventive layer is provided on a polyester film may be laminated on the outermost surface of the transparent laminate through an adhesive layer. Such commercial reflection-preventive film is e.g. REALOOK made by NOF Corporation.

Specific embodiments of the present invention that solves the third problems will be described in detail below as examples. Within the scope of the present invention, it is not limited by these Examples. In the Examples below, the spectral transmittance was measured by use of a spectrophotometer (UV3100PC made by SHIMADZU Corporation).

### EXAMPLE 6

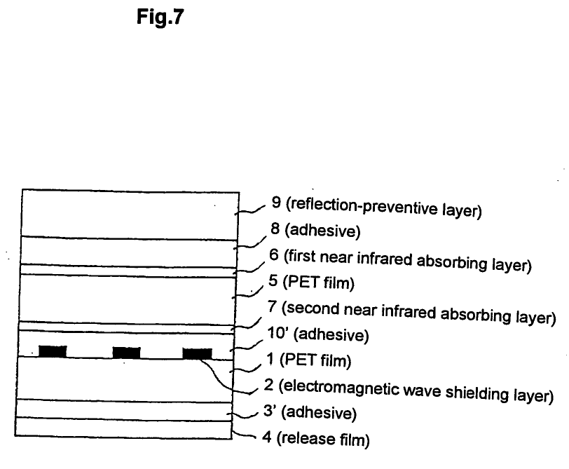

A filter having the structure shown in FIG. 7 was manufactured.

To a polyester (PET) film 1 (longitudinal tear strength 1.96 N/mm, lateral tear strength 1.96 N/mm, ratio of longitudinal tear strength/lateral tear strength=1.0, elongation: 100%) having a thickness of 100 micrometers used as the transparent resin substrate, copper was laminated on one side thereof nonelectrode plating to a thickness of 4 micrometers.

This copper layer was formed into a mesh having a wire width of 10 micrometers and a pitch of 300 micrometers by photoetching to form an electromagnetic wave shield layer 2.

Thereafter, on the side opposite to the mesh surface of the film, an adhesive layer 3′ was formed, and a release film 4 comprising a polyester film having a thickness of 38 micrometers was laminated thereon.

The thickness of the adhesive layer 3′ was 25 micrometers. At the edge, by sandwiching a polyester film therebetween at one location, a peel start point was formed.

The following coating liquid was applied to one side of a polyester film 5 (longitudinal tear strength: 1.96 N/mm, lateral tear strength: 1.96 N/mm, ratio of longitudinal tear strength/lateral tear strength=1.0, elongation: 100%) having a thickness of 50 micrometers.

Coating liquid: 5 wt % of a solution in which a near infrared absorber (aminothiol nickel complex salt pigment expressed by the formula (7)) was dissolved in a solvent (THF:toluene=1:1), by 0.2 wt %, and 5 wt % of a solution in which an acrylic resin as a binder was dissolved in a solvent (toluene) at the concentration of 30 wt % were mixed together to prepare a coating liquid.

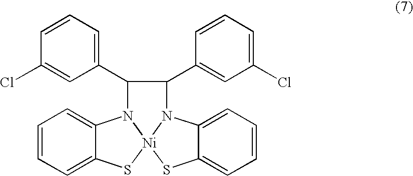

After application, the coating was dried (3 minutes at 110° C.) to form a first near infrared absorbing layer 6. The thickness of the first layer 6 after drying was 3 micrometers.

Next, the following coating liquid was applied to the side of the film opposite to the surface on which the first near infrared absorbing layer 6 was formed.

Coating liquid: 5 wt % of a solution in which a near infrared absorber (diimonium pigment) was dissolved in a solvent (methylethylketone:toluene=1:1) by 3 wt %, and 5 wt % of a solution in which an acrylic resin as a binder was dissolved in a solvent (toluene) at the concentration of 30 wt % were mixed together to obtain a coating liquid.

After application, it was dried (3 minutes at 110° C.) to form a second near infrared absorbing layer 7. The thickness of the second layer 7 after drying was 3 micrometers.

On the side of the film on which is provided the first near infrared absorbing layer 6, a reflection-preventive film 9 (REALOOK made by NOF Corporation) having an adhesive layer 8 was laminated to form a reflection-preventive layer.

Further, on the surface of the second near infrared absorbing layer 7, after applying an acrylic resin adhesive with a doctor roll, while drying, a release film comprising a polyester film having a thickness of 38 micrometers was laminated. The adhesive layer 10′ was 25 micrometers.

The adhesive layer of the film having the reflection-preventive layer and the near infrared absorbing layer was laminated on the mesh side of the electromagnetic wave shield film while peeling the release film to form a filter for a plasma display.

This filter was laminated on the surface of a plasma display panel (not shown).

It was applied while preventing bubbles from being trapped by pressing the filter against the surface of the plasma display while peeling the release film 4 from the peel start portion.

It was possible to laminate it without trapping large bubbles.

This transparent laminate showed excellent near infrared cutting performance, electromagnetic wave shielding performance, damage-preventive performance and transparency, so that it was suitable for use as a filter for a plasma display panel.

When this filter for a plasma display panel was laminated on soda-lime glass having a thickness of 2 mm and the glass was broken by applying impact, the film did not tear and it was possible to prevent scattering of the glass.

### EXAMPLE 7

Using an electromagnetic wave shield layer prepared by laminating silver/ITO/silver on one side of a polyester film having a thickness of 50 micrometers by vacuum deposition to the thickness of 20 nm, a filter for a plasma display panel was formed in the same manner as in Example 1.

### COMPARATIVE EXAMPLE 6

(On the electromagnetic wave shield layer used in Example 7, coating liquid of a near infrared absorber (diimonium pigment, the same as the second near infrared absorbing layer 7 of Example 5) was applied. It was dried (3 minutes at 110° C.) to form a near infrared absorbing layer. The thickness of the layer after drying was 3 μm On the side opposite the surface on which the near infrared absorbing layer was formed, after applying an acrylic resin adhesive solution with a doctor roll, and drying it a release film comprising a polyester film having a thickness of 38 micrometers was laminated.

A filter having a single transparent resin layer was thus formed. The thickness of the adhesive layer was 25 μm.

This filter was laminated on the surface of a plasma display panel.

It was applied while preventing bubbles from being trapped by pressing the filter against the plasma display while peeling the release film 4 from the peel start portion.

It was possible to laminate it without trapping large bubbles.

This transparent laminate showed excellent near infrared cutting performance, electromagnetic wave shielding performance and transparency. It was suitable for use as a filter for a plasma display panel.

But when this filter for a plasma display panel was laminated on soda-lime glass having a thickness of 2 mm and the glass was broken by applying impact, the film was torn and the glass scattered.

### EFFECT OF THE INVENTION

As described above, since the filter for an electronic display of the present invention that solves the first problem has a layer having a minimum value of transmittance in the wavelength range of 530-600 nm, it does not reduce emissions of the display so much, and also it is high in the effect of improving contrast of the display at bright portions.

With the filter for an electronic display of the present invention that solves the second problem, since differences in transmittance (%) at 435 nm, 545 nm and 610 nm are suppressed within 10, even if the external light is a fluorescent lamp such as F10 or F6, which has large emission peaks at 435 nm, 545 nm and 610 nm, the balance of emission spectrum will not be lost so much. Thus it is possible to suppress unnatural coloring of the filter due to ecternal light.

The filter for an electronic display of the present invention that solves the third problem is superior in the scattering-preventive effect. Nameby, even if the plasma display is destroyed due to impact during manufacture, transportation or after installation of the plasma display of which the body is made of glass. Also, it can be easily mounted to the surface of the plasma display.

1. (Cancelled)

2. A filter for an electronic display mounted on the front surface of the electronic display, characterized in that it has a minimum value of transmittance in a wavelength range of 530-600 nm, and that the luminous transmittance Y1 using an emission spectrum of the electronic display on which it is to be mounted is higher than the luminous transmittance Y2 using an emission spectrum (JIS Z8719-1996) of an ordinary fluorescent lamp F6, and that the relation between said luminous transmittances Y1 and Y2 is such that a filter contrast value C expressed by the formula (1)
C=(Y1)/(Y2)₂ (1)
is not less than 2.4.

3. A filter for an electronic display as claimed in claim 2 wherein said filter contains a compound having the maximum absorption in a wavelength range of 530-600 nm so that said filter has a minimum value of transmittance in the wavelength range of 530-600 mu.

4. A filter for an electronic display as claimed in claim 2 wherein said compound having the maximum absorption in the wavelength range of 530-600 nm is a squarylium compound expressed by the following formula (IA) 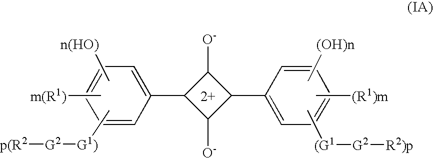
[wherein R¹ is an alkyl group which may have a substituent, an alkoxy group which may have a substituent, an aryl group which may have a substituent, an aryoloxy group which may have a substituent, or a halogen atom. Adjacent R¹'s may be coupled together to form an alkanediyl or alkylenedioxy group.
R² is a hydrogen atom or a monohydric substituent, G¹ is a group expressed by —NR³— (wherein R³ is a hydrogen atom or an alkyl group), or an oxygen atom, G² is a carbonyl group or a sulfonyl group (if G² is a sulfonyl group, R² is not a hydrogen atom.).
m, n and p are integers equal to or greater than 0, m+n+p being not more than 5.
These substituents on the benzene rings may be different from each other between the benzene rings. If m and n are 2 or larger in one benzene ring, the groups expressed by R¹ and G¹-G²-R² may be different from other groups in the same one benzene ring.]

5. A filter for an electronic display wherein it has at least one minimum value of transmittance in a visible light wavelength range of 400-700 nm and the difference between the minimum transmittance (%) among the local minimum transmittances and the maximum transmittance (%) in the visible light range is 10 or greater, and wherein when the transmittances (%) at wavelengths of 435 nm, 545 nm and 610 nm are compared, the difference between the maximum and minimum values of transmittance at these wavelengths is not more than 10.

6. A filter for an electronic display as claimed in claim 3 wherein the difference between the maximum and minimum values is restricted to 5 or under.

7. A filter for an electronic display as claimed in claim Sor 6 wherein the transmittances at wavelengths of 435 nm, 545 nm and 610 nm are 80-5%.

8. A filter for an electronic display as claimed in claim 7 wherein it has a minimum value of transmittance in a wavelength range of 530-600 nm.

9. A filter for an electronic display as claimed in claim 6 wherein it contains a compound having the maximum absorption in a wavelength range of 530-600 nm so that it has a minimum value of transmittance in the wavelength range of 530-600 nm.

10. A filter for an electronic display as claimed in claim 6 wherein it contains a compound having the maximum absorption near one of wavelengths of 435, 545 and 610 nm, whereby restricting the transmittance.

11. A filter for an electronic display wherein the compound defined in claim 9 is a squarylium compound expressed by the following formula (IB): 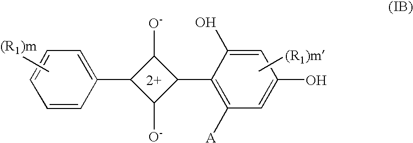
[In the formula (IB), R₁ is an alkyl group which may have a substituent, or an alkoxy group which may have a substituent, the substituent A is a hydroxy group or W—X—R₂ (where W is an imino group or an alkylimino group, X is a carbonyl group or a sulfonyl group, R₂ is a hydrogen atom, an alkyl group which may have a substituent, an alkenyl group which may have a substituent, an aryl group which may have a substituent, or a hetrocyclic group which may have a substituent, m=0 or an integer 1-4, m′=0 or 1.)]

12. A filter for an electronic display wherein the compound defined in claim 9 is a squarylium compound expressed by the following formula (II): 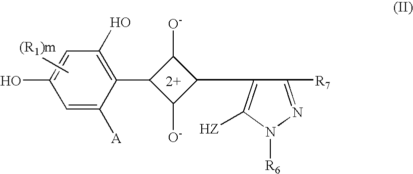
[In the formula (II), R₁ is an alkyl group which may have a substituent, or an alkoxy group which may have a substituent, the substituent A is a hydroxy group or W—X—R₂ (wherein W is an imino group or an alkylimino group, X is a carbonyl group or sulfonyl group, R₂ is a hydrogen atom, an alkyl group which may have a substituent, an alkenyl group which may have a substituent, an aryl group which may have a substituent, or a hetrocyclic group which may have a substituent, m is 0 or 1, R₆ and R₇ are an alkyl group which may have a substituent or an arly group which may have a substituent, and Z is an oxygen atom).

13. A filter for an electronic display as claimed in claim 9 wherein that compound defined in claim 9 is a squarylium compound expressed by the following formula (III): 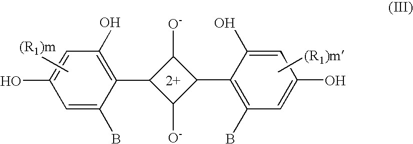
[wherein R₁ is an alkyl group which may have a substituent, or an alkoxy group which may have a substituent, the substituent B is W—CO—R₂ (wherein W is an imino group or an alkylimino group, R₂ is an alkenyl group which may have a substituent, or an alkynyl group which may have a substituent, m and m′ are independently 0 or 1.).]

14. A filter for an electronic display wherein said compound defined in claim 9 is a tetraazaporphyrin compound expressed by the following formula (XI-1 to XI-13).

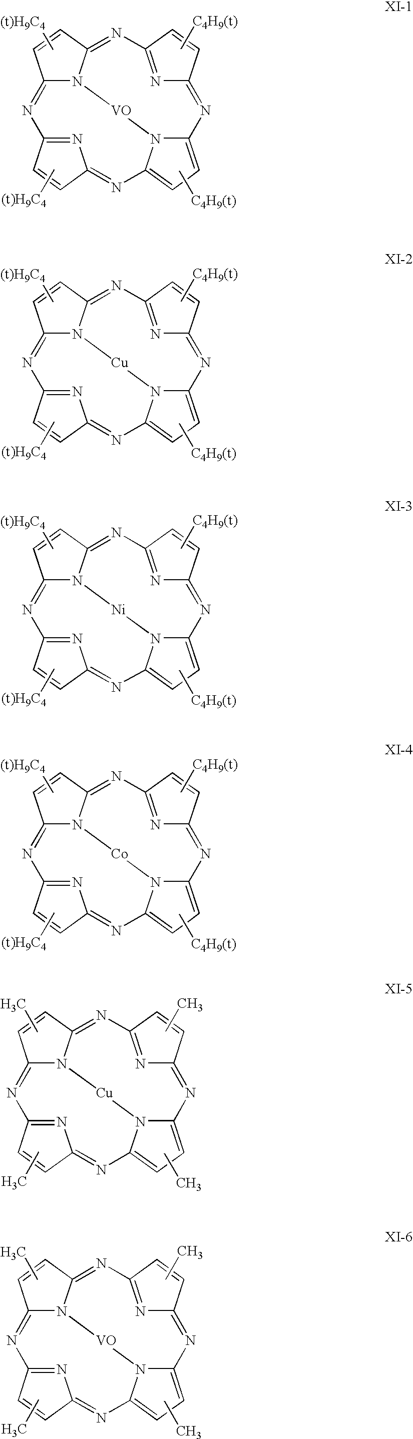

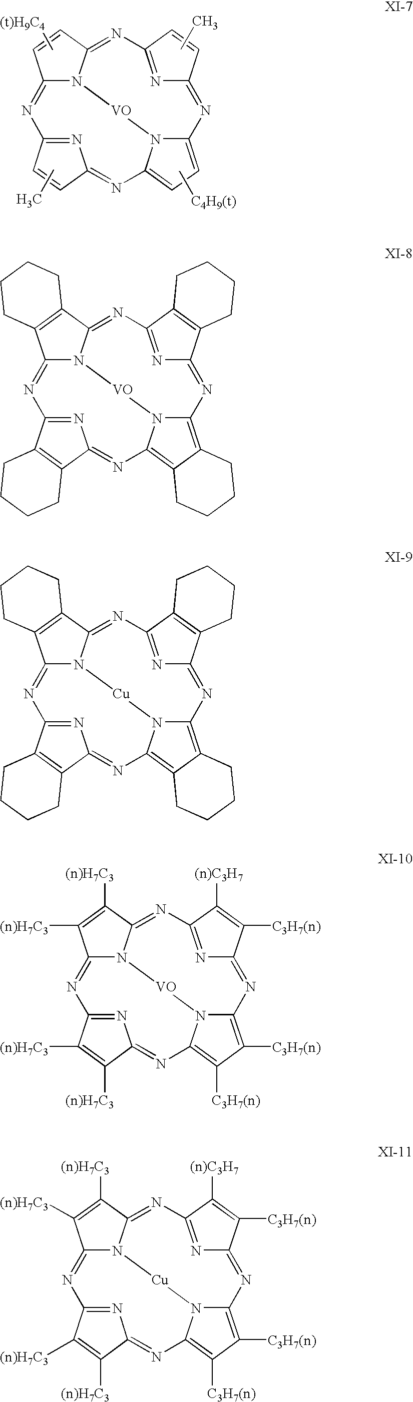

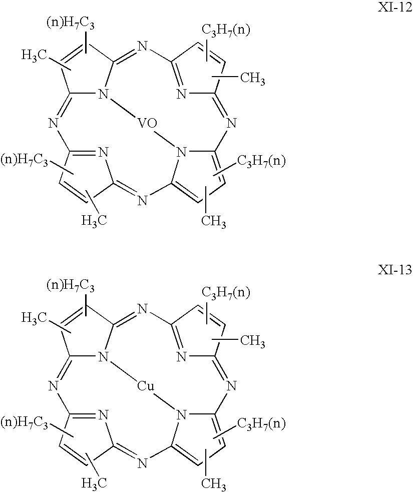

15. A filter for an electronic display as claimed in claim 2 wherein it has a layer containing an ultraviolet absorber.

16. A filter for an electronic display as claimed in claim 2 wherein it has a near infrared cutting layer.

17. A filter for an electronic display as claimed in claim 2 wherein it has an electromagnetic wave shielding layer.

18. A filter for an electronic display as claimed in claim 2 wherein it has a reflection-preventive layer.

19. A filter for an electronic display as claimed in claim 2 wherein it has a non-glare layer.

20. A filter for an electronic display as claimed in claim 2 wherein two or more transparent resin substrate layers and two or more adhesive layers are laminated.

21. A filter for an electronic display as claimed in claim 20 wherein said transparent resin substrate layers are each 40-300 micrometers thick, and the adhesive layers are each 5-3000 micrometers thick.

22. A filter for an electronic display as claimed in claim 20 wherein said transparent resin substrate layers have a tear strength of 1.5 N/mm or over, and the ratio of longitudinal tear strength/transverse tear strength is 0.5-2.0.

23. A filter for an electronic display as claimed in claim 20 wherein said transparent resin substrate layers are formed of a polyester resin having a visible light beam transmittance of 70% or over.

24. A filter for an electronic display as claimed in claim 20 wherein one of said adhesive layers is an adhesive layer to be stuck on the front surface of a plasma display panel with a release film provided on the surface thereof.

25. An electronic display device in which is used the filter for an electronic display as claimed in claim 2.

26. A filter for an electronic display as claimed in claim 5 wherein the transmittances at wavelengths of 435 nm, 545 nm and 610 nm are 80-5%.

27. A filter for an electronic display as claimed in claim 5 wherein it has a minimum value of transmittance in a wavelength range of 530-600 nm.

28. A filter for an electronic display as claimed in claim 5 wherein it contains a compound having the maximum absorption in a wavelength range of 530-600 nm so that it has a minimum value of transmittance in the wavelength range of 530-600 nm.

29. A filter for an electronic display wherein the compound defined in claim 28 is a squarylium compound expressed by the following formula (IB): 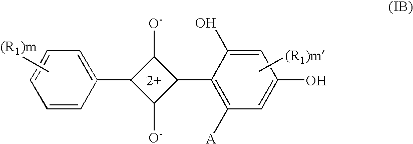
[In the formula (IB), R₁ is an alkyl group which may have a substituent, or an alkoxy group which may have a substituent, the substituent A is a hydroxy group or W—X—R₂ (where W is an imino group or an alkylimino group, X is a carbonyl group or a sulfonyl group, R₂ is a hydrogen atom, an alkyl group which may have a substituent, an alkenyl group which may have a substituent, an aryl group which may have a substituent, or a hetrocyclic group which may have a substituent, m=0 or an integer 1-4, m′=0 or 1.)]

30. A filter for an electronic display wherein the compound defined in claim 28 is a squarylium compound expressed by the following formula (II): 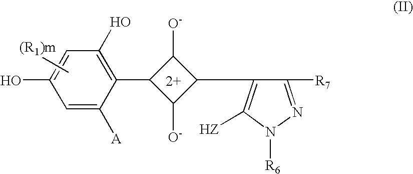
[In the formula (II), R₁ is an alkyl group which may have a substituent, or an alkoxy group which may have a substituent, the substituent A is a hydroxy group or W—X—R₂ (wherein W is an imino group or an alkylimino group, X is a carbonyl group or sulfonyl group, R₂ is a hydrogen atom, an alkyl group which may have a substituent, an alkenyl group which may have a substituent, an aryl group which may have a substituent, or a hetrocyclic group which may have a substituent, m is 0 or 1, R₆ and R₇ are an alkyl group which may have a substituent or an arly group which may have a substituent, and Z is an oxygen atom).

31. A filter for an electronic display as claimed in claim 9 wherein that compound defined in claim 28 is a squarylium compound expressed by the following formula (III): 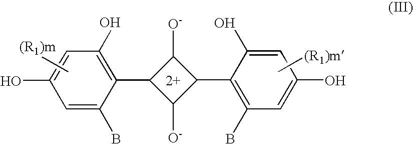
[wherein R₁ is an alkyl group which may have a substituent, or an alkoxy group which may have a substituent, the substituent B is W—CO—R₂ (wherein W is an imino group or an alkylimino group, R₂ is an alkenyl group which may have a substituent, or an alkynyl group which may have a substituent, m and m′ are independently 0 or 1.).]

32. A filter for an electronic display wherein said compound defined in claim 28 is a tetraazaporphyrin compound expressed by the following formula (XI-1 to XI-13).

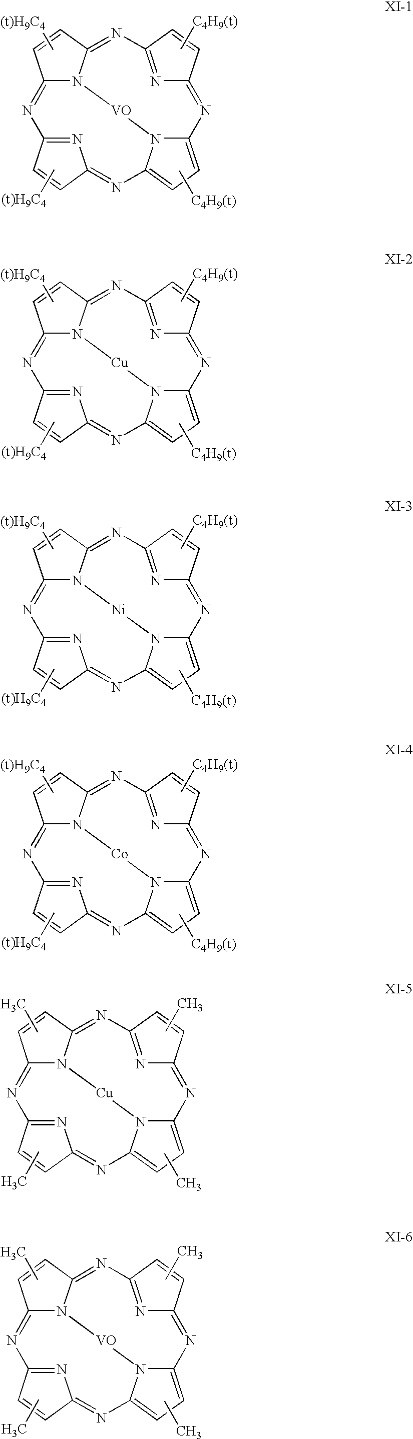

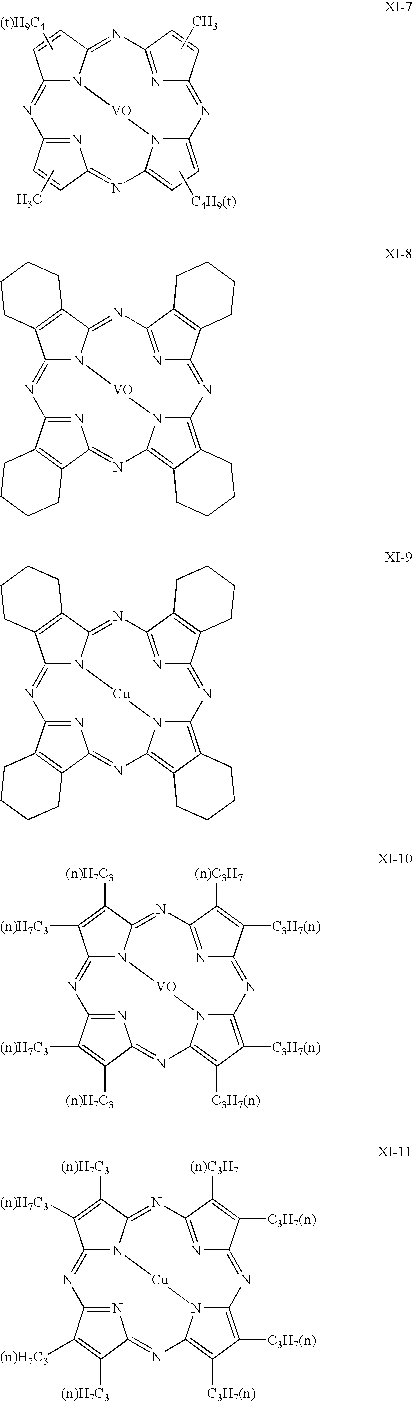

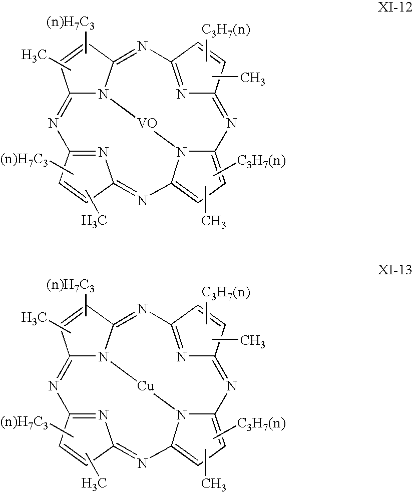

33. A filter for an electronic display as claimed in claim 5 wherein it contains a compound having the maximum absorption near one of wavelengths of 435, 545 and 610 nm, whereby restricting the transmittance.

34. A filter for an electronic display as claimed in claim 5 wherein it has a layer containing an ultraviolet absorber.

35. A filter for an electronic display as claimed in claim 5 wherein it has a near infrared cutting layer.

36. A filter for an electronic display as claimed in claim 5 wherein it has an electromagnetic wave shielding layer.

37. A filter for an electronic display as claimed in claim 5 wherein it has a reflection-preventive layer.

38. A filter for an electronic display as claimed in claim 5 wherein it has a non-glare layer.

39. A filter for an electronic display as claimed in claim 5 wherein two or more transparent resin substrate layers and two or more adhesive layers are laminated.

40. A filter for an electronic display as claimed in claim 39 wherein said transparent resin substrate layers are each 40-300 micrometers thick, and the adhesive layers are each 5-3000 micrometers thick.

41. A filter for an electronic display as claimed in claim 39 wherein said transparent resin substrate layers have a tear strength of 1.5 N/mm or over, and the ratio of longitudinal tear strength/transverse tear strength is 0.5-2.0.

42. A filter for an electronic display as claimed in claim 39 wherein said transparent resin substrate layers are formed of a polyester resin having a visible light beam transmittance of 70% or over.

43. A filter for an electronic display as claimed in claim 39 wherein one of said adhesive layers is an adhesive layer to be stuck on the front surface of a plasma display panel with a release film provided on the surface thereof.

44. An electronic display device in which is used the filter for an electronic display as claimed in claim 5.
